(19) United States
(12) Patent Application Publication
(10) Pub. No.: US 2010/0011318 A1
(43) Pub. Date: Jan. 14, 2010

(54) Image forming apparatus

(75) Inventors: Norihide Nakada, Osaka-shi (JP); Takeshi Nakamura, Osaka-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/458,475

(22) Filed: Jul. 14, 2009

(30) Foreign Application Priority Data
Jul. 14, 2008 (JP) JP2008-182863

(51) Int. Cl. G06F 3/048; G06F 21/00

(52) U.S. Cl. 715/808; 715/846; 726/17

(57) ABSTRACT

In one embodiment, when comment information is input for an operation key in an operation screen, and the comment information that has been input is displayed in the operation screen, if comment information has been input for an operation key, an icon giving notification that comment information has been input is displayed in the operation screen, or the display state of the operation key is made different from the display state when comment information is not input for the operation key.

### CROSS-REFERENCE TO RELATED APPLICATION

This application claims priority under 35 U.S.C. §119(a) on Patent Application No. 2008-182863 filed in Japan on Jul. 14, 2008, the entire contents of which are herein incorporated by reference.

### BACKGROUND OF THE INVENTION

1. Field of the Invention

The present invention relates to an image forming apparatus such as a digital copier, printer, facsimile apparatus, or digital multifunction peripheral.

2. Related Art

Recently, image forming apparatuses having a print function, such as a digital copier, printer, facsimile apparatus, or digital multifunction peripheral, have been equipped with various functions (for example, such as two-sided printing, color printing, reduced/enlarged printing, or a job program registration function for pre-registering a job operation sequence). Further, in the case of an apparatus having a send function, for example, an image forming apparatus such as a facsimile apparatus or digital multifunction peripheral, such an apparatus may possibly be equipped with various functions such as, for example, a one-touch registration or group registration, for pre-registering recipient identification information such as a facsimile number or electronic mail address. Also, there are image forming apparatuses provided with a function for authenticating a user.

With this type of image forming apparatus, ordinarily, by the user performing an operation to execute a desired function based on display information that is displayed on an operation screen of a display unit, the operated function is executed.

For example, JP 2003-118177A discloses an image forming apparatus in which, when an operator authentication means authenticates an operator using the input of a user name and a password of the operator from an operating means, a job memory management means combines and registers a plurality of copy conditions, and manages the registered copy conditions so that the registered copy conditions can be called when necessary, and manages registration and calling of the copy conditions on a per-operator basis for operators that have been authenticated by the operator authentication means.

Also, in the case of sending image data using a send function, ordinarily, by the user performing an operation to pre-register recipient identification information based on display information that is displayed on the operation screen of the display unit, the recipient identification information from the operation is registered, and by performing an operation for sending to the registered recipient, sending to the recipient in the operation is executed.

For example, JP 2006-114992A discloses a communications terminal apparatus provided with an individual phone book only for valid users, a group phone book for valid users belonging to a group, and an all-purpose phone book usable independently of the users, and use of the individual phone book, group phone book, or all-purpose phone book is allowed based on the results of user authentication.

JP 2006-191192A discloses an image sending apparatus in which definition information that defines a send destination is stored, and when sending image data based on selected definition information, approval or disapproval of send processing is decided, and the image data is sent when send processing has been approved.

However, in conventional image forming apparatuses, when the user performs an operation based on the display information displayed on the operation screen of the display unit, although useful information (for example, practical information that, although described in an operation manual or the like, is not displayed in the display unit and, although necessary to the user, therefore cannot be immediately obtained, an individual piece of information for a user such as notes, expertise information such as a specific operation method for a specific operation subject, and local information such as customary operating procedures in business) for that operation is necessary, the user that performs the operation cannot easily acquire useful information for that operation in fact.

Specifically, when copying a document such as an order form, it may be standard practice to erase 1 cm of the edge in a specific form, or when sending a document, the practice of contacting the recipient by telephone after sending, depending on the recipient, may be necessary. In such cases, conventionally, per instance of copying, or per instance of sending, troublesome work such as adding a hand-written memo to the original is necessary, and this causes a decrease in the work efficiency for operations such as a copy operation and a sending operation.

### SUMMARY OF THE INVENTION

It is an object of the present invention to provide an image forming apparatus with which information useful to a user that operates the apparatus can be easily acquired, so that the work efficiency for operations can be improved.

The present invention provides an image forming apparatus in the following first and second aspect.

### (1) Image Forming Apparatus in First Aspect

An image forming apparatus capable of executing a function corresponding to an operation key displayed in an operation screen by the operation key being operated includes an input unit (input means) that inputs comment information for an operation key in the operation screen and a display control unit (display control means) that displays the comment information input by the input unit in the operation screen. The display control unit displays an icon that gives notification that comment information has been input in the operation screen when the input unit has input comment information for the operation key.

In the image forming apparatus in a first aspect according to the present invention, the input unit inputs comment information useful to the user for the operation key, and the display control unit displays the comment information input by the input unit in the operation screen.

As described above, according to the image forming apparatus in the first aspect according of the present invention, information useful to the user is input as comment information for the operation key, and the input comment information is displayed in the operation screen; thus, it is possible to easily acquire useful information and, to that extent, the work efficiency for operations can be improved.

Furthermore, when comment information has been input for the operation key, an icon giving notification that comment information has been input is displayed in the operation screen; thus, this enables the user to easily recognize that comment information has been input for the operation key.

In the image forming apparatus in the first aspect according to the present invention, the display control unit can display the content of the comment information only when it is detected that a comment display operation for displaying the content of the comment information in the operation screen has been performed (for example, when it is detected that the icon has been operated). In this case, comment information is not unnecessarily displayed in the operation screen, which can prevent the operation screen from being complicated due to the display of comment information.

For the image forming apparatus in the first aspect according to the present invention, the following specific aspects can be given as examples. That is,

(a1) an aspect in which an authentication unit that performs user authentication is further provided, and the display control unit is made capable of changing a color of the icon to be displayed in the operation screen for each user authenticated by the authentication unit,

(b1) an aspect in which an authentication unit that performs user authentication is further provided, and the display control unit is made capable of changing a shape of the icon to be displayed in the operation screen for each user authenticated by the authentication unit, and

(c1) an aspect obtained by the combination of the (a1) and (b1).

### (2) Image Forming Apparatus in Second Aspect

An image forming apparatus capable of executing a function corresponding to an operation key displayed in an operation screen by the operation key being operated includes an input unit (input means) that inputs comment information for an operation key in the operation screen and a display control unit (display control means) that displays the comment information input by the input unit in the operation screen. When the input unit has input comment information for the operation key, the display control unit makes a display state of the operation key different from a display state in which comment information is not input for the operation key (for example, the color or the shape is changed).

In the image forming apparatus in a second aspect according to the present invention, the input unit inputs comment information useful to the user for the operation key, and the display control unit displays the comment information input by the input unit in the operation screen.

As described above, according to the image forming apparatus in the second aspect of the present invention, information useful to the user is input as comment information for the operation key, and the comment information that has been input is displayed in the operation screen; thus, it is possible to easily acquire useful information and, to that extent, the work efficiency for operations can be improved.

Furthermore, in the case in which comment information has been input for the operation key, the display state of the operation key is made different from the display state when comment information is not input for the operation key (for example, the color or the shape is changed); thus, this enables the user to easily recognize that comment information has been input for the operation key.

In the image forming apparatus in the second aspect according to the present invention, the display control unit can display the content of the comment information only when it is detected that a comment display operation for displaying the content of the comment information in the operation screen has been performed (for example, when it is detected that the operation key has been operated). In this case, comment information is not unnecessarily displayed in the operation screen, which can prevent the operation screen from being complicated due to the display of comment information.

For the image forming apparatus in the second aspect according to the present invention, the following specific aspects can be given as examples. That is,

(a2) an aspect in which an authentication unit that performs user authentication is further provided, and the display control unit is made capable of changing a color of the operation key to be displayed in the operation screen for each user authenticated by the authentication unit when the input unit has input comment information for the operation key,

(b2) an aspect in which an authentication unit that performs user authentication is further provided, and the display control unit is made capable of changing a shape of the operation key to be displayed in the operation screen for each user authenticated by the authentication unit when the input unit has input comment information for the operation key, and

(c2) an aspect obtained by a combination of the (a2) and (b2).

In the image forming apparatuses in the first and second aspects according to the present invention, when it is detected that a comment display operation for displaying the content of the comment information in the operation screen has been performed (for example, when it is detected that the icon has been operated in the image forming apparatus in the first aspect, and when it is detected that the operation key has been operated in the image forming apparatus in the second aspect), the display control unit preferably displays the content of the comment information in the operation screen using a pop-up screen.

In this case, it is possible to display the content of the comment information in a different screen using the pop-up screen on the operation screen. Consequently, it is possible to easily display the content of the comment information at one time even when the number of characters that can be input is increased. Therefore, even in the case of a comment including many sentences, it is possible for the user to easily understand the content of the comment information.

In this case, the image forming apparatus may have a configuration in which the size of the pop-up screen is changed in accordance with the number of letters in the comment information, or a configuration in which a letter size is automatically adjusted so as to fit in the pop-up screen.

Furthermore, in the image forming apparatuses in the first and second aspects according to the present invention, the display control unit can also simultaneously display an instruction key used to give instructions to start an operation to process a corresponding function when displaying the pop-up screen.

In this case, it is possible to directly give instructions to start an operation using the instruction key after confirming the content of the comment information, thus enabling an improvement in operation convenience.

The image forming apparatuses in the first and second aspects according to the present invention may further be provided with a send function for sending image data.

As described above, according to the image forming apparatuses in the first and second aspects of the present invention, information useful to the user is input as comment information for the operation key in the operation screen, and the comment information that has been input is displayed in the operation screen; thus, it is possible to easily acquire information useful to the user and, consequently, the work efficiency for operations can be improved.

Further, in the image forming apparatus in the first aspect according to the present invention, an icon giving notification that comment information has been input is displayed in the operation screen when comment information has been input for the operation key. On the other hand, in the image forming apparatus in the second aspect according to the present invention, in the case in which comment information has been input for the operation key, the display state of the operation key is made different from the display state when comment information is not input for the operation key. Therefore, this enables the user to easily recognize that comment information has been input for the operation key.

### BRIEF DESCRIPTION OF THE DRAWINGS

FIG. 1 is a schematic diagram that shows the overall configuration of an image processing system that is constructed using a digital multifunction peripheral according to an embodiment of the present invention.

FIG. 2 is a block diagram that shows the internal configuration of the digital multifunction peripheral.

FIG. 3 is a schematic diagram that shows an example of the data structure of a function information management table.

FIG. 4 is a schematic diagram that shows an example of the data structure of a comment information management table.

FIG. 5A is a schematic diagram that shows an example of an operation panel. FIG. 5B is a schematic diagram that shows an example of an initial screen displayed in a display unit of the operation panel

FIGS. 6A to 6C are schematic diagrams that show an example of a screen selectively displayed when a system settings key shown in FIG. 5A has been pressed.

FIG. 7A is a schematic diagram that shows an example of a screen displayed in a display unit when setting one-touch key assignment.

FIG. 7B is a schematic diagram that shows another example of a screen displayed in the display unit when setting one-touch key assignment.

FIG. 7C is a schematic diagram that shows a variation of the screen shown in FIG. 7B.

FIG. 8 is a schematic diagram that shows an example of a comment information input screen displayed when a comment information key shown in FIG. 6A has been pressed.

FIG. 9 is a flowchart that shows an example of processing for inputting comment information for a function information operation key 81 displayed in an operation screen in a system settings mode.

FIG. 10 is a schematic diagram that shows an example of a function operation screen displayed when an image send key has been pressed in the initial screen shown in FIG. 5B.

FIG. 11A is a schematic diagram that shows an example of an operation screen displayed when a function selection key has been pressed in the function operation screen shown in FIG. 10. FIG. 11B shows an enlarged view of comment information in FIG. 11A.

FIG. 12A is a schematic diagram that shows an example of an operation screen displayed when a special function key has been pressed in the initial screen shown in FIG. 5B. FIG. 12B shows an enlarged view of comment information in FIG. 12A.

FIGS. 13A and 13B illustrate an example of a comment information input operation in a function execution mode. FIG. 13A is a schematic diagram that shows another example of an operation screen displayed when the function selection key has been pressed in the function operation screen shown in FIG. 10. FIG. 13B is a schematic diagram that shows an example of a comment input screen displayed when a comment information input key has been pressed in the operation screen shown in FIG. 13A.

FIGS. 14A and 14B illustrate an example of a comment information input operation in the function execution mode. FIG. 14A is a schematic diagram that shows another example of an operation screen displayed when the special function key has been pressed in the initial screen shown in FIG. 5B. FIG. 14B is a schematic diagram that shows an example of a comment input screen displayed when a comment information input key has been pressed in the operation screen shown in FIG. 14A.

FIG. 15A is a schematic diagram that shows still another example of an operation screen displayed when the function selection key has been pressed in the function operation screen shown in FIG. 10. FIG. 15B shows an enlarged view of comment information in FIG. 15A.

FIG. 16A is a schematic diagram that shows still another example of an operation screen displayed when the special function key has been pressed in the initial screen shown in FIG. 5B. FIG. 16B shows an enlarged view of comment information in FIG. 16A.

FIGS. 17A and 17B illustrate an example of a comment information input operation in the function execution mode. FIG. 17A is a schematic diagram that shows still another example of an operation screen displayed when the function selection key has been pressed in the function operation screen shown in FIG. 10. FIG. 17B is a schematic diagram that shows an example of a comment input screen displayed when a comment information input key has been pressed in the operation screen shown in FIG. 17A.

FIGS. 18A and 18B illustrate an example of a comment information input operation in the function execution mode. FIG. 18A is a schematic diagram that shows still another example of an operation screen displayed when the special function key has been pressed in the initial screen shown in FIG. 5B. FIG. 18B is a schematic diagram that shows an example of a comment input screen displayed when a comment information input key has been pressed in the operation screen shown in FIG. 18A.

FIG. 19 is a flowchart that shows an example of processing for displaying and inputting comment information for function information displayed in an operation screen in the function execution mode.

FIG. 20 is a schematic diagram that shows another example of the data structure of the comment information management table.

FIG. 21 shows a login screen displayed in the display unit when performing user authentication.

FIG. 22 is a schematic diagram that shows another example of a screen displayed in the display unit when setting one-touch key assignment shown in FIG. 7A.

FIG. 23 is a schematic diagram that shows a detailed view of part of the comment information management table shown in FIG. 20.

FIG. 24 is a schematic diagram that shows another example of the screen shown in FIG. 7C.

FIG. 25 is a flowchart that shows another example of processing for inputting comment information for function information displayed in an operation screen in the system settings mode.

FIG. 26 (divided into two partial views: FIGS. 26A and 26B) is a flowchart that shows another example of processing for displaying and inputting, for each user, comment information for function information displayed in an operation screen in the function execution mode.

FIG. 27 is a diagram that shows an example of the case in which when sending image data by electronic mail, comment information and also an instruction key used to give instructions to start an operation to process a function corresponding to a function execution key are simultaneously displayed using a pop-up screen on an operation screen.

FIG. 28 (divided into two partial views: FIGS. 28A and 28B) is a flowchart that shows processing for displaying the content of comment information in the operation screen using the pop-up screen, in the flowchart shown in FIG. 26.

FIG. 29 shows example comments that are input in the operation screens of various functions.

### DESCRIPTION OF THE PREFERRED EMBODIMENTS

Hereinafter, embodiments in which an image forming apparatus according to the present invention is applied to a digital multifunction peripheral having a print function, a copy function, a facsimile send/receive function, and so forth will be specifically described with reference to the attached drawings that show such embodiments. It should be noted that the embodiments below are embodied examples of the present invention, and are not of a nature that limits the technical scope of the present invention.

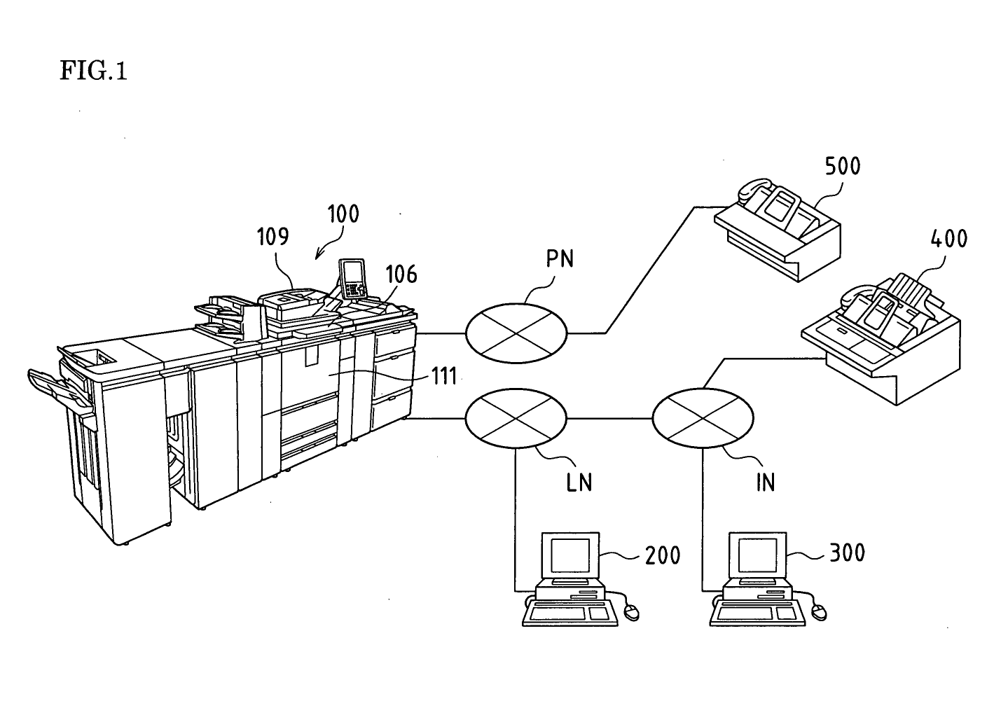

FIG. 1 is a schematic diagram that shows the overall configuration of an image processing system that is constructed using a digital multifunction peripheral according to an embodiment of the present invention.

In FIG. 1, reference numeral 100 denotes a digital multifunction peripheral according to an embodiment of the present invention. Various external devices are connected to this digital multifunction peripheral 100 via a communications network. For example, an external computer 200 such as a personal computer is connected to a communications network LN, which is deployed as a local communications network, and an external computer 300 and an internet facsimile apparatus 400 (hereinafter, referred to as simply the facsimile apparatus 400) are connected to an internet network IN, which is connected via a connection means such as a gateway, not shown. Also, an external facsimile apparatus 500 is connected via a public telephone network PN.

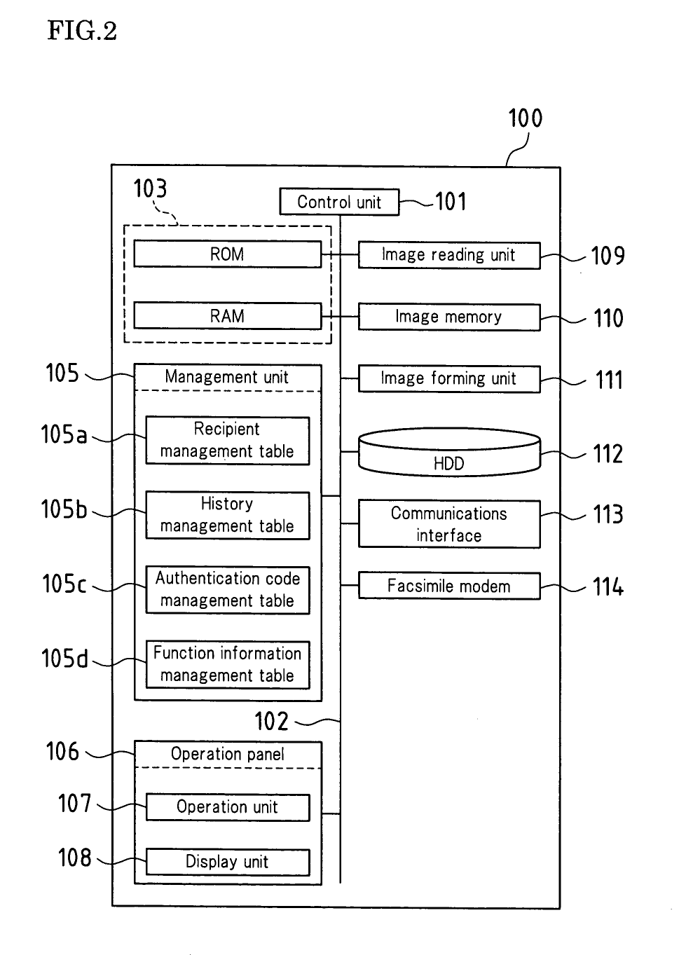

FIG. 2 is a block diagram that shows the internal configuration of the digital multifunction peripheral 100. The digital multifunction peripheral 100 is provided with a control unit 101, which includes a processing apparatus such as a CPU, and a main storage unit 103, which includes memories such as a ROM and a RAM.

Specifically, the digital multifunction peripheral 100, by the CPU of the control unit 101 loading a control program that has been pre-stored in the ROM of the main storage unit 103 into the RAM of the main storage unit 103 and executing that loaded control program, controls hardware that has been connected via a bus 102, and thus operates that hardware as a whole as an image forming apparatus, and an image sending apparatus and an image receiving apparatus.

The following is a description of the configurations of various pieces of hardware connected to the bus 102. A management unit 105 is configured from a nonvolatile semiconductor memory, and part of the storage area thereof is used for a recipient management table 105a, in which recipient identification information such as the electronic mail addresses and facsimile numbers of destinations is managed, a history management table 105b, in which a history of executed processes is managed, an authentication code management table 105c, in which authentication codes (here, user identification codes and passwords that identify users) are managed, and a function information management table 105d, in which display information on various functions is managed.

An operation panel 106 is configured from an operation unit 107 for receiving an operation from a user, and a display unit 108 for displaying information to be notified to the user. The operation unit 107 is provided with operation members, such as various operation keys and number keys for receiving the input of a function switching operation, the number of output pages in print processing, magnification in copy processing, a send destination in facsimile-sending processing, and the like. The display unit 108 is provided with a display apparatus (for example, a liquid crystal display apparatus), and displays display information such as the operating status of the digital multifunction peripheral 100 and settings values that have been input from the operation unit 107. Also, the display unit 108 is provided with a touch panel input apparatus having software keys configured so as to receive various selection operations by a user's input operation (for example, a pressing operation) to a display screen.

An image reading unit 109 is provided with an original platen where an original to be read is placed, a light source that applies light to the original to be read, an image sensor such as a CCD (Charge Coupled Device), and an optical member such as an AD converter (all not shown). In the image reading unit 109, an image of the original that has been placed at a predetermined reading position is formed on the image sensor and converted to an analog electrical signal, the obtained analog electrical signal is AD-converted to a digital signal by the AD converter, and digital-format image data is produced by correcting the light distribution properties of the light source, the sensitivity variation of the image sensor, and so forth during original reading on the obtained digital signal.

An image memory 110 is, for example, a volatile page memory, and temporarily stores various image data, such as image data acquired by the image reading unit 109, image data extracted from a print job, and image data extracted from facsimile data. In the digital multifunction peripheral, image data that has been temporarily stored in the image memory 110 is transferred to a transfer destination according to the intended use of that data according to an instruction from the control unit 101. That is, image data that has been temporarily stored is transferred to an image forming unit 111 when an image will be formed on a sheet such as a paper, transferred to a large-capacity storage memory (here, the hard disk apparatus (HDD)) 112 when the data will be saved using a filing function, transferred to a communications interface 113 after being attached to an electronic mail that includes recipient address information when the data will be sent as an electronic mail, and transferred to a facsimile modem 114 when the data will be sent as facsimile data.

The image forming unit 111 forms an image on a sheet based on image data that has been transferred from the image memory 110. Specifically, the image forming unit 111 is provided with image forming members (all not shown) such as a charging unit that charges a photosensitive drum to a predetermined potential, a laser writing apparatus that emits laser light according to image data that has been received from outside to produce an electrostatic latent image on the photosensitive drum, a development unit that supplies toner to the electrostatic latent image that has been formed on the surface of the photosensitive drum to form a visible image, and a transfer unit that transfers the toner image formed on the surface of the photosensitive drum onto a sheet. Also, the image forming unit 111 forms an image desired by a user on a sheet using an electrophotograhic method. Note that other than forming an image by an electrophotographic method employing a laser writing apparatus, the image forming unit 111 may form an image by another method, such as an inkjet method, a thermal transfer method, or a sublimation method.

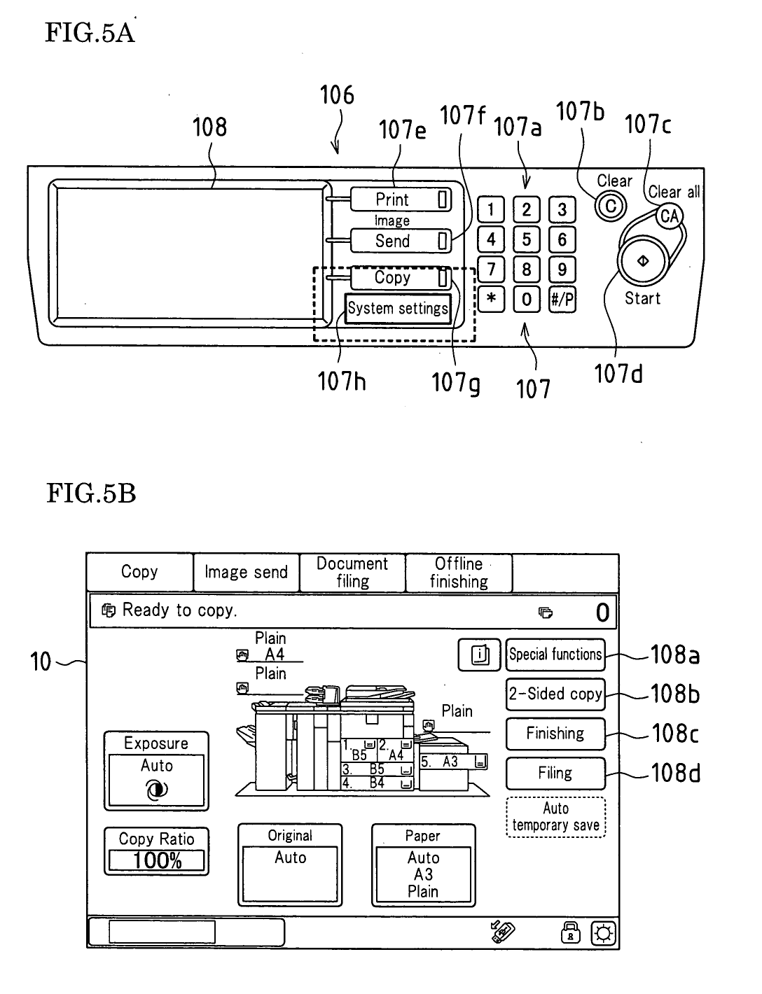

The HDD 112 is a hard disk apparatus that has a hard disk controller and a disk-shaped magnetic recording medium. In the HDD 112, by the control unit 101 giving an instruction to the hard disk controller, data writing processing or reading processing is performed. Also, in the HDD 112, a part of a storage area is used as a data area for storing image data, and when a request has been received via the operation panel 106, or when a request has been received from the external computer 200 or 300 via the communications interface 113, the image data stored in the data area is read out. Accordingly, in this digital multifunction peripheral 100, when it is necessary to execute print processing again because of a print processing failure, inadequate output copies, or the like, the image data stored in the data area can be arbitrarily read out to execute print processing. Note that in this embodiment, in the HDD 112, it is possible to use a part of the storage area for a comment information management table 112a (see FIG. 4, described later).

The communications interface 113 is provided with a communications interface compliant with the communications standards of the communications network LN, and can be connected to the communications network LN and the Internet network IN. With the communications interface 113 provided with this configuration, a print job can be received from the external computer 200 on the connected communications network LN, and also, an electronic mail sent from the external computer 300 on the internet network IN and facsimile data sent from the facsimile apparatus 400 can be received. Also, with the communications interface 113, information to be notified to the external computer 200 can be sent, and also, an electronic mail can be sent to the external computer 300 on the internet network IN, and facsimile data can be sent to the facsimile apparatus 400. Thus, the communications interface 113 can control the sending/receiving of various data.

The facsimile modem 114 is provided with a line termination circuit for connecting to the external facsimile apparatus 500 via the public telephone network PN, and is capable of sending/receiving facsimile data to/from the connected facsimile apparatus 500. Specifically, the facsimile modem 114 is provided with a decoding circuit for decoding received facsimile data, and an encoding circuit for encoding facsimile data to be sent. Also, the facsimile modem 114 is capable of executing this sort of facsimile data encoding processing and decoding processing, as well as processing for sending/receiving encoded facsimile data.

### [Description of Distinguishing Portions of the Present Invention]

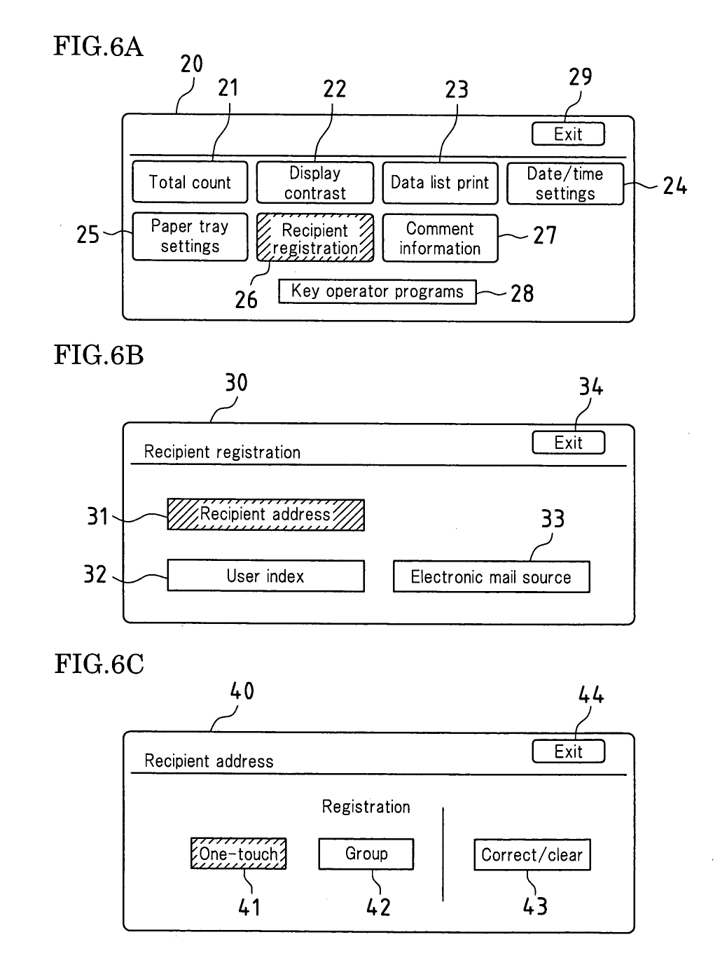

The digital multifunction peripheral 100 according to the present embodiment can execute functions corresponding to operation keys through the selection of such an operation key displayed in an operation screen of the display unit 108 (see FIG. 5A, described later), and is provided with an input means that inputs comment information for operation keys in an operation screen of the display unit 108 and a display control means that displays comment information that has been input by the input means in an operation screen of the display unit 108.

Specifically, this digital multifunction peripheral 100 is provided with the operation unit 107, into which operation information indicating a user operation is input; a function information storage unit (here, the function information management table 105d) that stores display information on various functions (function information); a comment information storage unit (here, the comment information management table 112a) that stores comment information; the display unit 108, in which a plurality of operation screens are selectively displayed based on the function information that has been stored in the function information storage unit; and the control unit 101, which performs overall control of the digital multifunction peripheral 100. Note that in the present embodiment, the function information storage unit is configured with the function information management table 105d of the management unit 105, and the comment information management unit is configured with the comment information management table 112a, which is a part of the HDD 112.

The control unit 101 is provided with an input control means that inputs comment information for function information operation keys (here, the operation keys corresponding to the function information stored in the function information management table 105d) displayed in an operation screen of the display unit 108, a storage control means that stores comment information that has been input by the input control means such that the comment information is associated with the corresponding function information in the comment information storage unit (hereinafter, referred to as the comment information management table 112a), a read control means that reads out comment information that has been stored in the comment information management table 112a by the storage control means along with the corresponding function information from the comment information management table 112a, and the display control means that displays, in an operation screen of the display unit 108, comment information read out from the comment information management table 112a by this read control means, such that the comment information is associated with the corresponding function information operation key; which will be described in more detail later. Further, the control unit 101 is configured so as to perform the operations described in the following first and second embodiments.

### First Embodiment

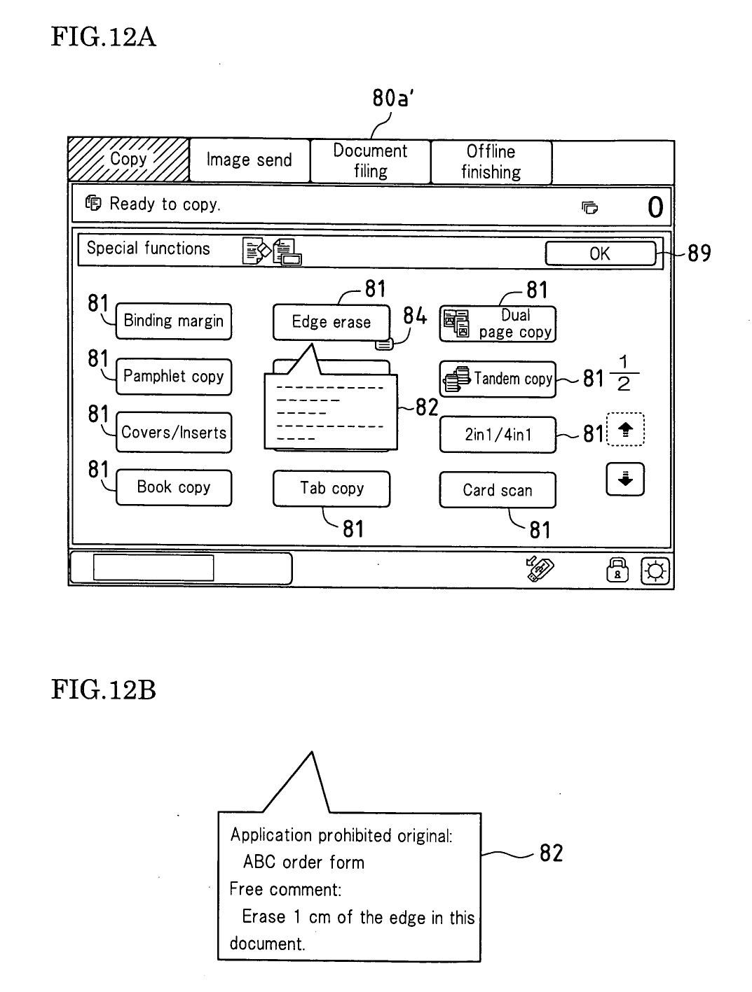

In the first embodiment, as shown in FIGS. 11 to 14B described later, when comment information 82 has been input for an operation key 81 by the input control means, the display control means displays an icon 84 giving notification that comment information has been input in the vicinity of the operation keys 81 in an operation screen 80a, 80a′, 80b, or 80b′ of the display unit 108.

### Second Embodiment

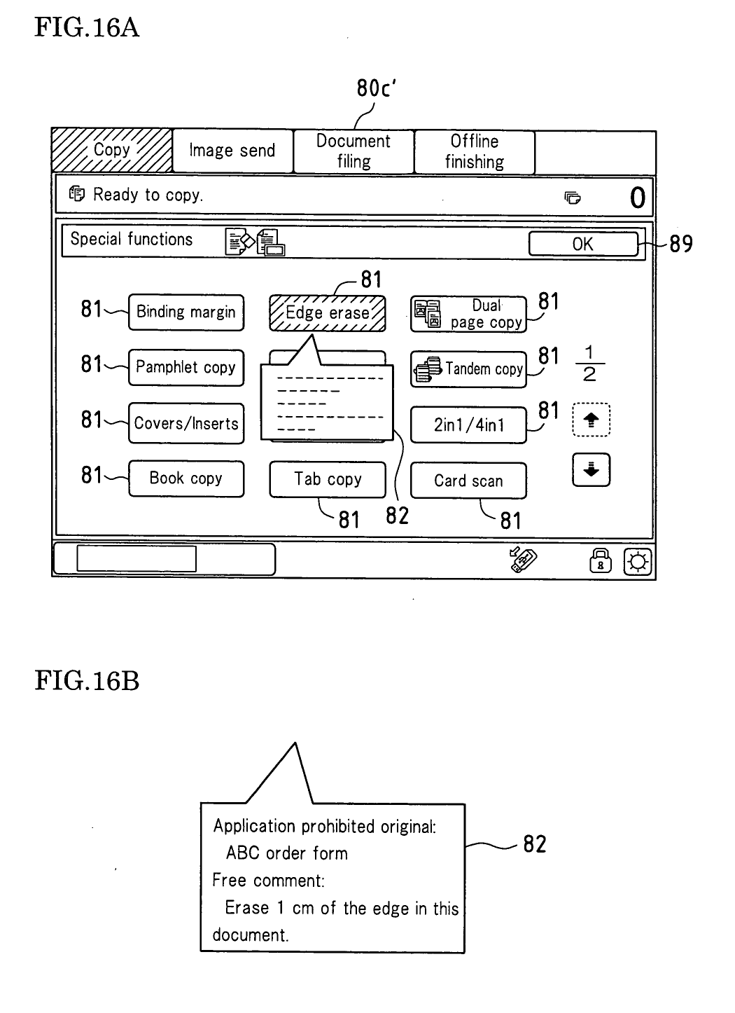

In the second embodiment, as shown in FIGS. 15A to 18B described later, when the input control means has input comment information 82 for an operation key 81 displayed in the operation screen 80a, 80a′, 80b, or 80b′ of the display unit 108, the display control means makes the display state of the operation key 81 different from the display state in which the comment information 82 is not input for the operation key 81 (here, the color is changed (see a diagonally shaded area in the figures)).

According to the digital multifunction peripheral 100 of the first embodiment or second embodiment of the present invention, as comment information 82 for an operation key 81 in an operation screen, information useful to the user (for example, a comment “erase 1 cm of the edge” in the case of copying a document such as an order form, or a comment “contact by phone after sending” in the case of sending a document) is input, and the comment information 82, which has been input, is displayed in the operation screen of the display unit 108. By doing so, when the user performs an operation based on display information displayed on the operation screen of the display unit 108, information useful for that operation can easily be acquired, so it is possible to reduce input errors and improve operability.

Further, the digital multifunction peripheral 100 according to the first embodiment displays, in the operation screen, the icon 84 giving notification that comment information has been input when comment information 82 has been input for an operation key 81. On the other hand, in the case in which comment information 82 has been input for an operation key 81, the digital multifunction peripheral 100 according to the second embodiment makes the display state of the operation key 81 different from the display state when comment information 82 is not input for the operation key 81 (here, a color is changed). Therefore, this enables the user to easily recognize that comment information 82 has been input for the operation key 81.

In the first and second embodiments of the present invention, comment information 82 includes text information. The input control means inputs text comment information 82 for a function information operation key 81 displayed in the operation screen of the display unit 108. Further, the display control means displays, in the display unit 108, text comment information 82 read out by the read control means from the comment information management table 112a such that the comment information is associated with the corresponding function information operation key 81.

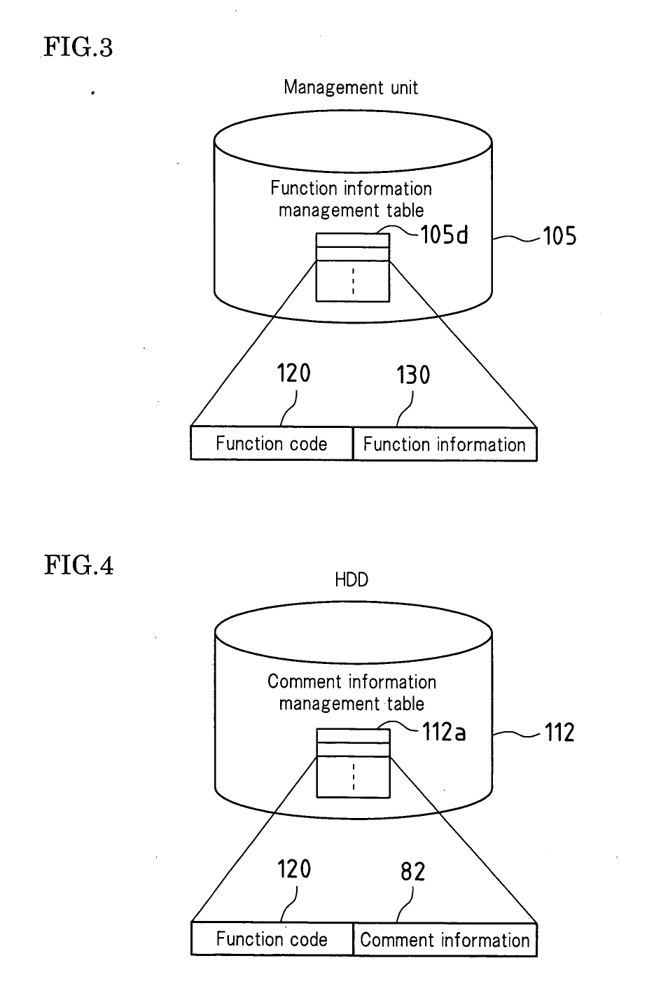

FIG. 3 is a schematic diagram that shows an example of the data structure of the function information management table 105d, and FIG. 4 is a schematic diagram that shows an example of the data structure of the comment information management table 112a.

As shown in FIG. 3, function information 130 is stored in the function information management table 105d, being associated with a function code 120, which identifies function information. As shown in FIG. 4, comment information 82 is stored in the comment information management table 112a, being associated with the function code 120. Thus, the comment information 82 can be associated with the corresponding function information 130.

In the first and second embodiments of the present invention, the control unit 101 is capable of executing a system settings mode in which various settings are set in advance in accordance with the intended use or usage conditions, and a function execution mode in which various functions are executed. Note that the settings set in the system settings mode are not particularly limited and, for example, one-touch registration, group registration, special functions, and the like can be set. Also, the functions performed in the function execution mode are not particularly limited and, for example, various print functions such as two-sided printing, color printing, reduced/enlarged printing, and a job program registration function, and various send functions such as a facsimile sending function using a public phone line or the Internet can be executed.

### (System Settings Mode)

In the first and second embodiments of the present invention, the input control means configured by the control unit 101 inputs comment information for function information operation key 81 displayed in an operation screen in the system settings mode.

This will be described, in the system settings mode, giving, as an example, a case in which comment information is input when registering a recipient to a one-touch key (shortcut key), and then described for an example case in which comment information is input for various functions (specifically, an edge erase function).

First, an operation performed when registering an electronic mail address and a facsimile number to a one-touch key will be described using a screen displayed in the display unit 108 of the operation panel 106.

FIG. 5A is a schematic diagram that shows an example of the operation panel 106. As described above, the operation panel 106 is configured from the operation unit 107 provided with various hardware keys and the display unit 108 constituted from a display apparatus and a touch-panel type input apparatus. The hardware keys provided to the operation unit 107 include a numeric keypad 107a for numerical input, a clear key 107b for clearing a settings value that has been input, a clear all key 107c for clearing all of various settings that have been input, and a start key 107d, which receives an instruction to start copying, start sending, and so forth. In addition to these, the hardware keys include function switching keys 107e, 107f, and 107g, which respectively switch to a print function, a send function, and a copy function, and also a system settings key 107h, which receives settings set by a user. Note that FIG. 5B shows an enlarged view of an initial screen 10 for awaiting copy processing displayed in the display unit 108. Various keys 108a to 108d configured as software keys are disposed in the initial screen 10. The control unit 101 is configured so as to be capable of setting a special function such as edge erase, setting a two-sided copy function, setting a finishing function such as staple processing, and setting a filing function for saving image data, respectively, by these keys 108a to 108d being pressed.

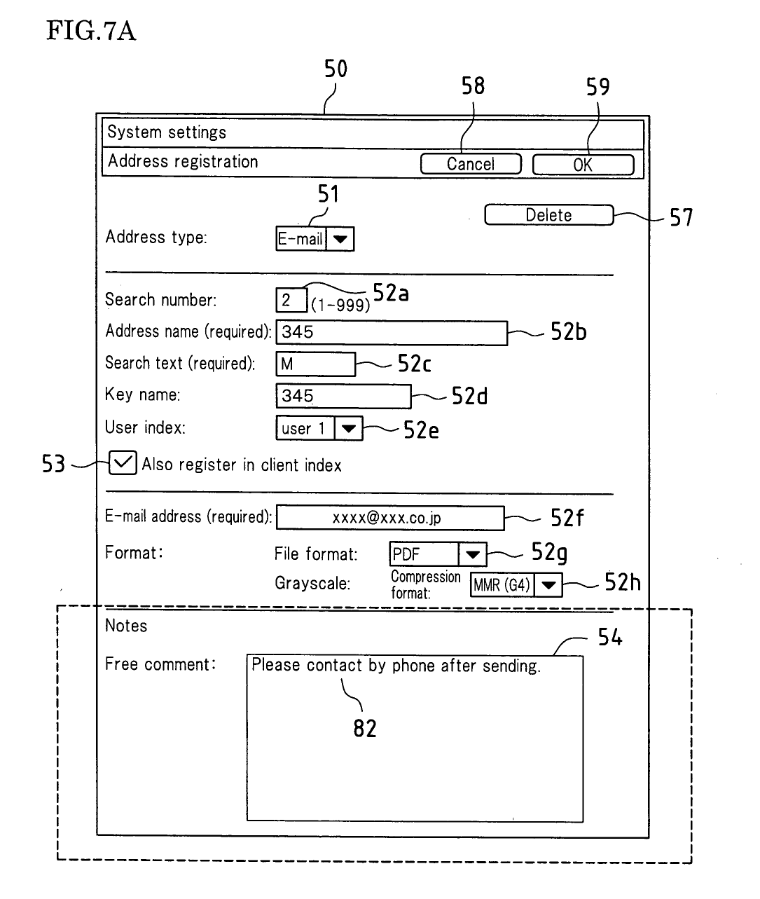

FIGS. 6A to 6C are schematic diagrams that show an example of a screen selectively displayed when the system settings key 107h shown in FIG. 5A has been pressed.

When the system settings key 107h in the operation panel 106 shown in FIG. 5A has been pressed, the control unit 101 displays, in the display unit 108, a settings menu screen 20 shown in FIG. 6A instead of the initial screen 10 as shown in FIG. 5B. Various keys 21 to 28 configured as software keys are disposed in the settings menu screen 20.

The control unit 101 can display the total number of pages that have been printed out, set the display contrast, request the output of various data lists, set the date and time, set a paper feed tray, register a recipient when sending data, input comment information, and set various settings set by an apparatus administrator by these keys 21 to 28 being respectively pressed. Also, when an exit key 29 disposed in the upper part of the settings menu screen 20 has been pressed, the settings menu screen 20 is closed, and the initial screen 10 shown in FIG. 5B is displayed in the display unit 108. Note that comment information 82 can be input by pressing the various keys 21 to 27 here. Among these keys, first, by way of example, the case of inputting comment information by pressing a recipient registration key 26 will be described.

When the recipient registration key 26 has been pressed in the settings menu screen 20 shown in FIG. 6A, a recipient registration screen 30 shown in FIG. 6B is displayed instead of the settings menu screen 20 in the display unit 108. An address settings key 31 for setting the communication addresses (facsimile number and electronic mail address) of a recipient, a user index settings key 32 for creating or correcting an address index, and a send source settings key 33 used to set information for the send source of an electronic mail are disposed in the recipient registration screen 30. When the keys 31 to 33 have been pressed, the operation content in the recipient registration screen 30 is fixed, and when an exit key 34 disposed in the upper part of the screen has been pressed, a process to return to the above settings menu screen 20 is performed.

When the address settings key 31 has been pressed in the recipient registration screen 30 shown in FIG. 6B, a registration content settings screen 40 shown in FIG. 6C is displayed instead of the recipient registration screen 30 in the display unit 108. A one-touch registration key (key assignment key) 41 for setting the assignment of a one-touch key to a recipient communication address, a group registration key 42 for grouping communication addresses, and a correct/clear key 43 for correcting or clearing registration content are disposed in the registration content settings screen 40. When the keys 41 to 43 have been pressed, the operation content in the registration content settings screen 40 is fixed, and when an exit key 44 disposed in the upper part of the screen has been pressed, a process to return to the recipient registration screen 30 shown in FIG. 6B is performed.

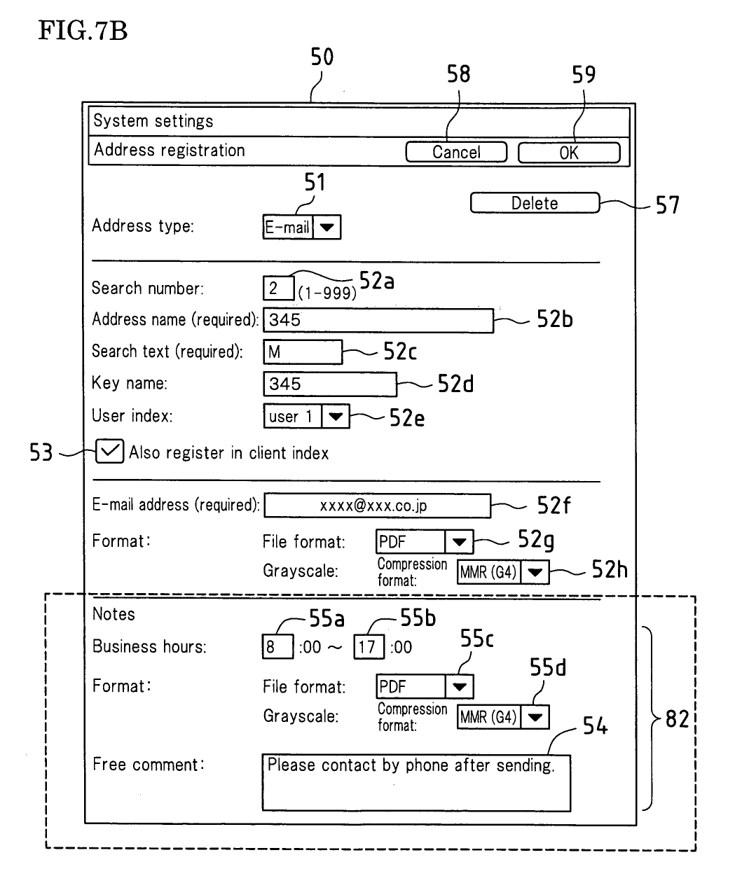

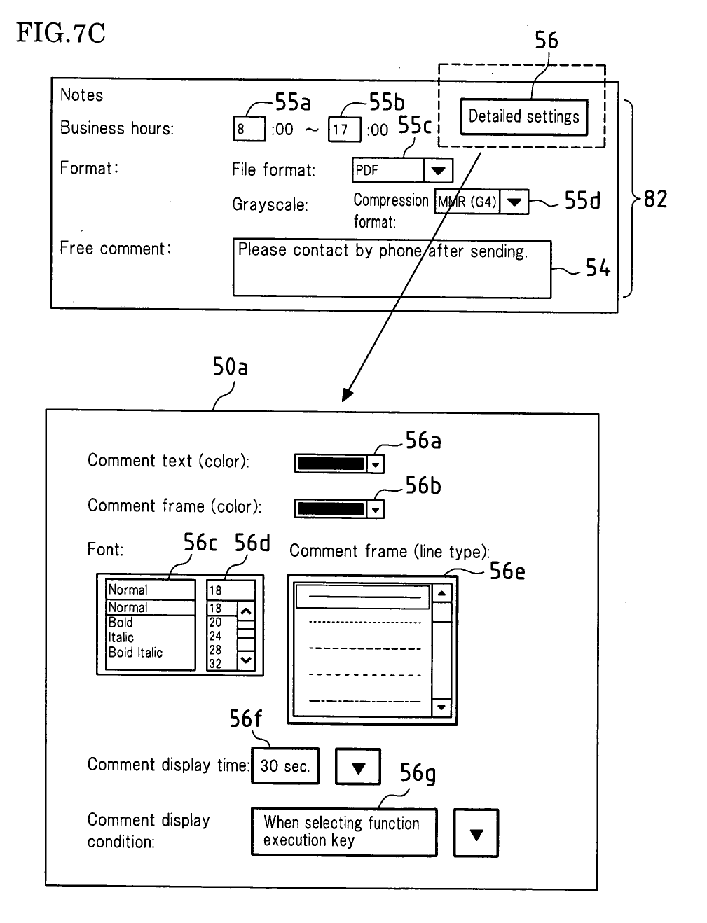

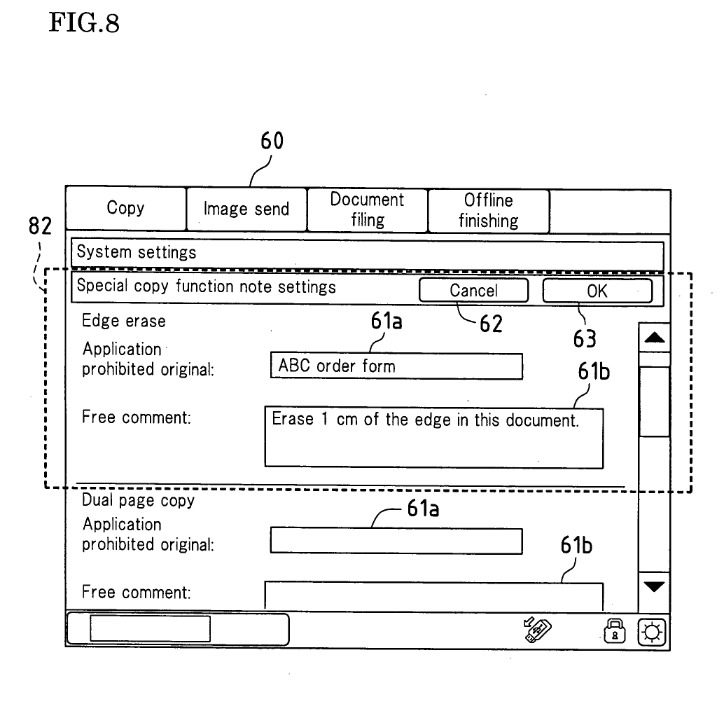

FIG. 7A is a schematic diagram that shows an example of a screen displayed in the display unit 108 when setting one-touch key assignment.

When the one-touch registration key 41 has been pressed in the registration content settings screen 40 shown in FIG. 6C, an address settings screen 50 shown in FIG. 7A is displayed instead of the registration content settings screen 40 in the display unit 108.

FIG. 7A shows an example of an address settings screen for assigning a one-touch key to an electronic mail address.

A selection key (here, a pull-down menu key) 51 for selecting a destination type of ‘E-mail’ or ‘fax’, recipient registration boxes 52a to 52h for inputting recipient registration content, and a selection key (here, a checkbox) 53 used to set the input content in a client index are disposed in the address settings screen 50 shown in FIG. 7A.

When ‘fax’ has been selected by operating the selection key 51, a facsimile number can be set, and when ‘E-mail’ has been selected, an electronic mail address can be set.

In the recipient registration boxes 52a to 52h, respectively, it is possible to input a search number used to search for a recipient, a recipient name, search text used to search for a recipient, a key name to be displayed in an address book separate from a destination name, a user index type for use in an address book screen, a recipient electronic mail address or facsimile number, an image data file format, and an image data compression format. Also, when a check has been entered in the checkbox 53, a setting to display in a client tab is set, and when a check is not entered in the checkbox 53, a setting not to display in the client tab is set.

When a delete key 57 in the upper part of the screen has been pressed, the registration content is deleted, and when a cancel key 58 has been pressed, a process to return to the settings menu screen 20 shown in FIG. 6A is performed. When an OK key 59 has been pressed, the input content of the address settings screen 50 is fixed, and a process to return to the settings menu screen 20 shown in FIG. 6A is performed.

Comment information 82 is input into a comment input box 54. In the first and second embodiments of the present invention, comment information 82 includes a free comment that the user can arbitrarily write. The input control means configured by the control unit 101 is made capable of inputting a free comment for the function information displayed in the operation screen of the display unit 108. Also, the display control means configured by the control unit 101 is made capable of displaying free comment that has been input by the input control means, such that the comment is associated with the corresponding function in the display unit 108.

In this example, an individual piece of comment information 82 for a user is input into the comment input box 54, such as a note “contact by telephone after sending” with respect to recipient 345.

FIG. 7B is a schematic diagram that shows another example of a screen displayed in the display unit 108 when setting one-touch key assignment. In FIG. 7B, the same elements as those shown in FIG. 7A are given the same reference numerals, and a description thereof is omitted.

In the address settings screen 50 shown in FIG. 7B, comment information 82 includes a stylized comment in which a predetermined phrase has been set in advance. The input control means configured by the control unit 101 can input a stylized comment for function information displayed in an operation screen of the display unit 108. Also, the display control means configured by the control unit 101 can display the stylized comment that has been input by the input control means, such that the comment is associated with the corresponding function in the display unit 108.

In this example, the stylized comment includes the business hours (start time and end time) of the recipient, the file format of attached image data, and the compression format of attached image data. In comment input boxes 55a to 55d, respectively, an individual piece of information for a user such as notes regarding business opening times, business closing times, file format, and compression format is input.

FIG. 7C is a schematic diagram that shows a variation of the screen shown in FIG. 7B. In FIG. 7C, the same elements as those shown in FIG. 7B are given the same reference numerals, and a description thereof is omitted. Note that in FIG. 7C, the comment input box unit of the address settings screen 50 is shown above, and a detailed settings screen 50a is also shown below.

In the comment input box shown in FIG. 7C, by pressing a detailed settings key 56, detailed settings of the comment information 82 can be set.

Here, the input control means configured by the control unit 101 performs visual modification processing on comment information 82, and the display control means configured by the control unit 101 displays comment information 82, on which the input control means has performed visual modification processing. Also, the input control means inputs display conditions when the display control means displays comment information 82 in the display unit 108, and the display control means displays comment information 82 based on the display conditions that have been input by the input control means.

In this example, the comment information 82 includes information on visual modification processing, such as the color designation of comment text, the color designation of a comment frame, the comment text font type, the comment text size, and the designation of a line type for the comment frame including information indicating whether or not to display the comment frame. In comment input boxes 56a to 56e, respectively, a comment text color, a comment frame color, a comment text font type, a comment text size, and a comment frame line type (no comment frame in the case of selecting no line type) are input.

Also, the settings for the display conditions when displaying comment information 82 in the display unit 108 include the setting of a comment display time when displaying comment information 82 for only a predetermined fixed time from the start of display (for example, the setting of any time period from 1 to 30 seconds), as described later, and the setting of a display condition with respect to the manner of display for comment information in the display unit 108 (for example, a setting for either when selecting a comment display icon in the first embodiment or when selecting a function execution key in the second embodiment), as described later. The comment display time and comment display condition are entered into comment input boxes 56f and 56g, respectively.

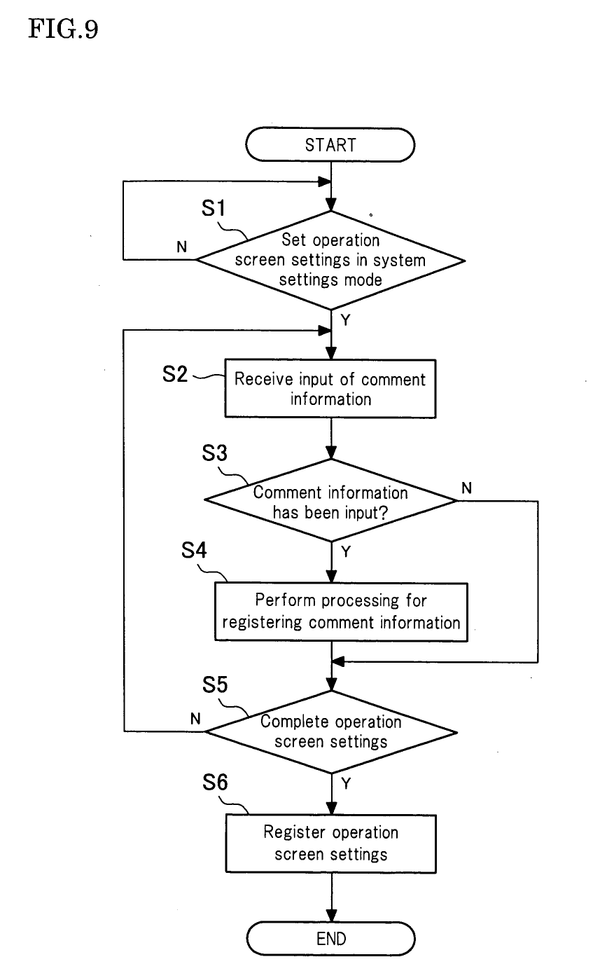

Next is a description of the input of comment information for various functions (for example, a function such as special-copy-function note settings or duplicate copy). When a comment information key 27 has been pressed in the settings menu screen 20 shown in FIG. 6A, a comment information input screen 60 shown in FIG. 8 is displayed in the display unit 108 instead of the settings menu screen 20.

FIG. 8 is a schematic diagram that shows an example of a comment information input screen displayed when the comment information key 27 shown in FIG. 6A has been pressed.

In the comment information input screen 60 shown in FIG. 8, for respective function information pieces, a stylized comment input box 61a for inputting stylized items (for example, a type of application prohibited original for which printing with this function is prohibited) and a free comment input box 61b for inputting a free comment are disposed. Here, various pieces of function information are displayed downward in a list, so that a scrolling display of function information that is not presently viewable in the display screen is possible.

When a cancel key 62 in the upper part of the screen has been pressed, a process to return to the settings menu screen 20 shown in FIG. 6A is performed, and when an OK key 63 has been pressed, the input content in the comment information input screen 60 is fixed, and a process to return to the settings menu screen 20 shown in FIG. 6A is performed.

In this example, a document type ‘ABC order form’ is entered for the comment of the stylized item “application prohibited original” of this special copy function in the stylized comment input box 61a, and the text “Please erase 1 cm of the edge in this document . . . ” for this special copy function is entered in the free comment input box 61b.

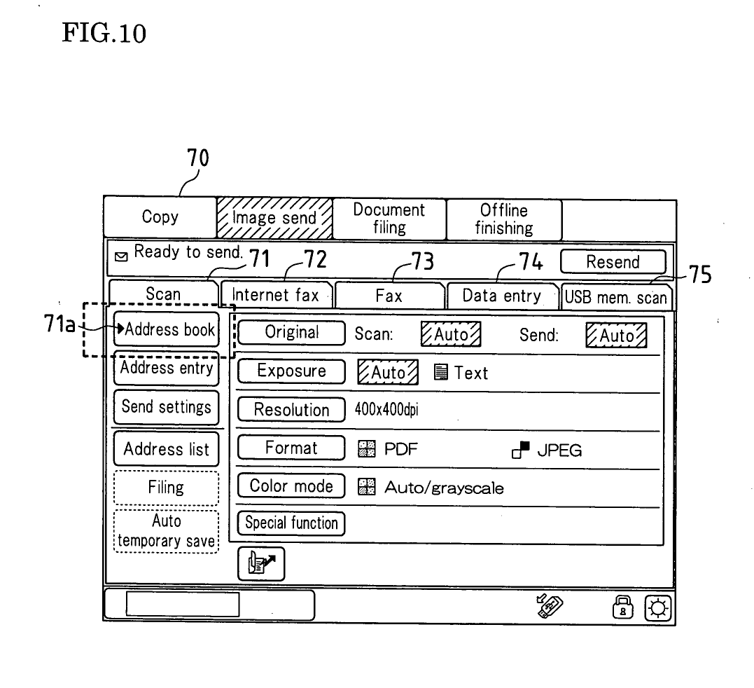

Next is a description of the operational flow of processing for inputting such comment information 82 for function information displayed in an operation screen in the system settings mode, with reference to FIG. 9.

FIG. 9 is a flowchart that shows an example of processing for inputting comment information 82 for function information displayed in an operation screen in the system settings mode.

In the processing shown in FIG. 9, first, a request to set a setting of an operation screen in the system settings mode is awaited (for example, an address book registration request or a request to set settings of various functions) (Step S1: N). When such a setting is requested (Step S1: Y), the input of comment information 82 (for example, see FIGS. 7A to 7C, and FIG. 8) is received (Step S2).

Next, it is determined whether or not comment information 82 has been input (Step S3), and when comment information 82 has not been input (Step S3: N), the processing proceeds to Step S5. On the other hand, when comment information 82 has been input (Step S3: Y), comment information 82 is registered in the comment information management table 112a, being associated with the corresponding function information 130 (Step S4), and then the processing proceeds to Step S5.

Then, it is determined whether or not settings for the operation screen in the system settings mode have been completed (Step S5), and when the settings for the operation screen have not been completed (Step S5: N), the processing proceeds to Step S2. On the other hand, when the settings for the operation screen have been completed (Step S5: Y), the processing proceeds to Step S6. In Step S6, settings for the operation screen are registered (here, registration to the address book in the recipient management table 105a of the management unit 105 or setting of an erasure size for edge erase), and processing ends.

### (Function Execution Mode)

In the first and second embodiments of the present invention, in the function execution mode, the display control means configured by the control unit 101 displays comment information 82 input by the input control means, such that the comment information is associated with the corresponding function information operation key 81.

This will be described, by way of example, for both the case in which comment information 82 is displayed when image data is sent by electronic mail in the function execution mode, and the case in which comment information 82 is displayed when executing various functions.

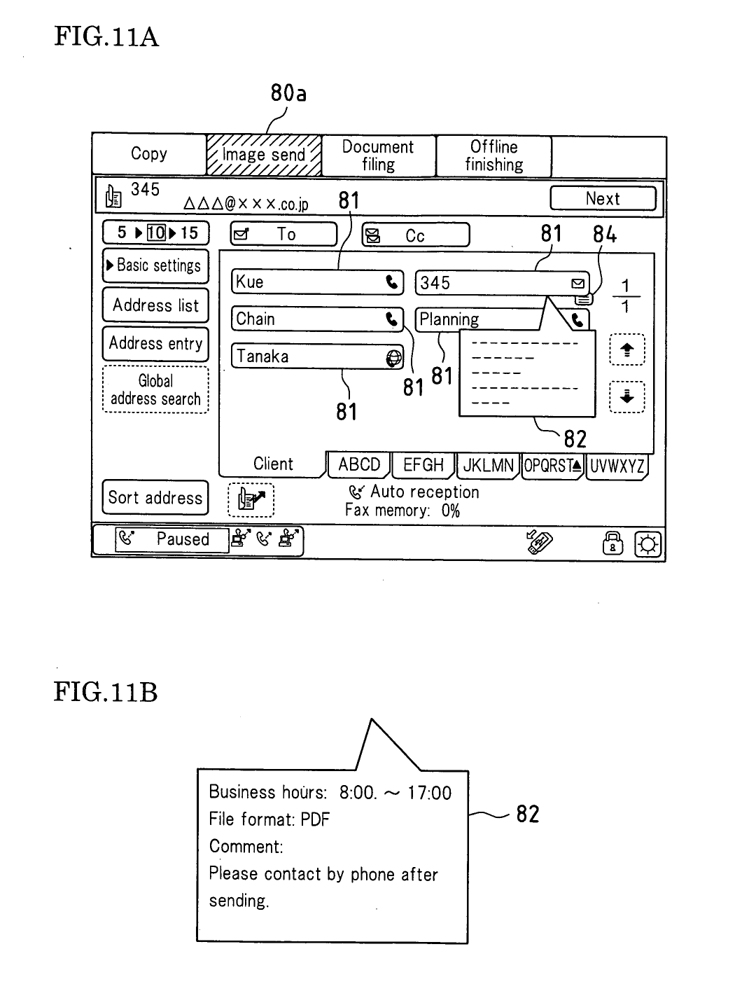

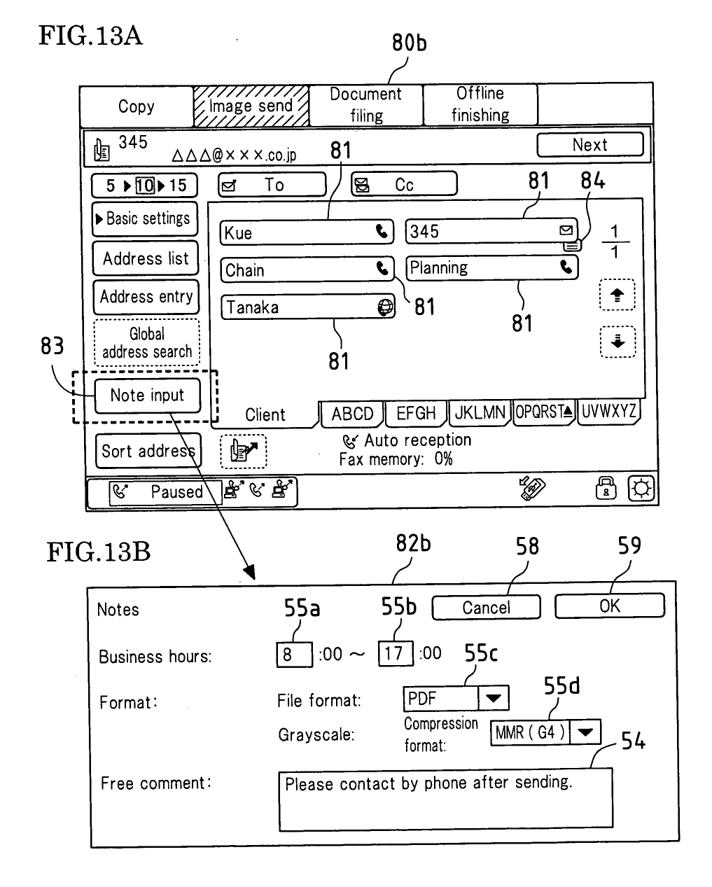

FIG. 10 is a schematic diagram that shows an example of a function operation screen displayed when the image send key 107f has been pressed in the initial screen shown in FIG. 5B. FIG. 11A is a schematic diagram that shows an example of an operation screen displayed when a function selection key (here, an address book key) 71a has been pressed in a function operation screen 70 shown in FIG. 10, and shows a state in which comment information 82 is displayed when sending image data by electronic mail. FIG. 11B shows an enlarged view of comment information 82 in FIG. 11A. FIG. 12A is a schematic diagram that shows an example of an operation screen displayed when the special function key 108a has been pressed in the initial screen shown in FIG. 5B, and shows a state in which comment information 82 is displayed when executing the edge erase function. FIG. 12B shows an enlarged view of comment information in FIG. 12A.

When the image send key 107f has been pressed in the operation panel 106 shown in FIG. 5A, the control unit 101 displays the function operation screen 70 shown in FIG. 10 instead of the initial screen 10 as shown in FIG. 5B in the display unit 108. Various send function keys 71 to 75 configured as software keys are disposed in the function operation screen (here, an image sending screen) 70.

By these send function keys 71 to 75 being pressed, the control unit 101 sends an image file read by scanning by electronic mail, sends an image file read by scanning by facsimile via the Internet, sends an image file read by scanning by facsimile via a public phone line, sends an image file read by scanning to the storage unit of a designated FTP (File Transfer Protocol) server, or sends an image file read by scanning to a USB (Universal Serial Bus) memory connected to the digital multifunction peripheral 100, respectively.

When the function selection key 71a has been pressed in the function operation screen 70 shown in FIG. 10, the control unit 101 displays the operation screen (here, an address book screen) 80a shown in FIG. 11A in the display unit 108 instead of the function operation screen 70.

On the other hand, when the special function key 108a has been pressed in the operation panel 106 shown in FIG. 5A, the control unit 101 displays the operation screen (here, a special function settings screen) 80a′ shown in FIG. 12A in the display unit 108 instead of the initial screen 10.

### Regarding First Embodiment

Here, in the first embodiment, as shown in FIGS. 11A to 12B, the display control means configured by the control unit 101 displays the comment information display icon 84 giving notification that comment information has been input, in the operation screen of the display unit 108 (here, in the vicinity of a software key 81 used to designate a recipient ‘345’ in the address book screen 80a, or a software key 81 used to set ‘edge erase’ in the special function settings screen 80a′) when the input control means has input the comment information 82 for the operation key 81 in the operation screen 80a or 80a′. Further, the display control means displays comment information 82 in the operation screen of the display unit 108 when an operation is performed so as to select and display the comment information 82 for the function information operation key 81 (here, information on the image send function or a special function) displayed in the operation screen (here, when the comment information display icon 84 is pressed).

Specifically, in the function execution mode, the display control means is made capable of displaying a function execution key 81 (here, an example of an operation key) for executing various functions in the operation screen 80a or 80a′ of the display unit 108 such that the input of a selection is possible, and also displaying the comment information display icon 84 for displaying the comment information 82 in the operation screen 80a or 80a′, such that the display icon is associated with the corresponding function execution key 81 and the input of a selection is possible. Note that the comment information display icon 84 can be displayed only when comment information 82 has been input (when comment information 82 exists). Also, when the comment information display icon 84 displayed in the operation screen 80a or 80a′ has been selected, the display control means is made capable of displaying (here, displaying in a dialog balloon such that part of another function execution key 81 is concealed), with respect to a function execution key 81 corresponding to that comment information display icon 84, the comment information 82 for the function (here, the send function to recipient ‘345’ or the edge erase function) corresponding to the function execution key 81.

With this configuration, the comment information display icon 84 is displayed only when comment information 82 has been input, so it is possible for the user to easily recognize whether or not comment information 82 exists. In addition, it is possible to display comment information 82 for a function execution key 81 displayed in the operation screen 80a or 80a′ of the display unit 108 only when the user wants to confirm that information. Furthermore, comment information 82 can be displayed when the comment information display icon 84 displayed in the operation screen 80a or 80a′ has been selected; thus, as the space to display comment information 82, only the space to display the selected comment information 82 is necessary, and to that extent, it is possible to save space for the display space of the operation screen 80a or 80a′ and, also, comment information 82 for a function that will be executed (here, the image send function or the edge erase function) can be uniquely specified. As a result of this, it is possible to reliably inform the user of the comment information 82 for the function that will be executed.

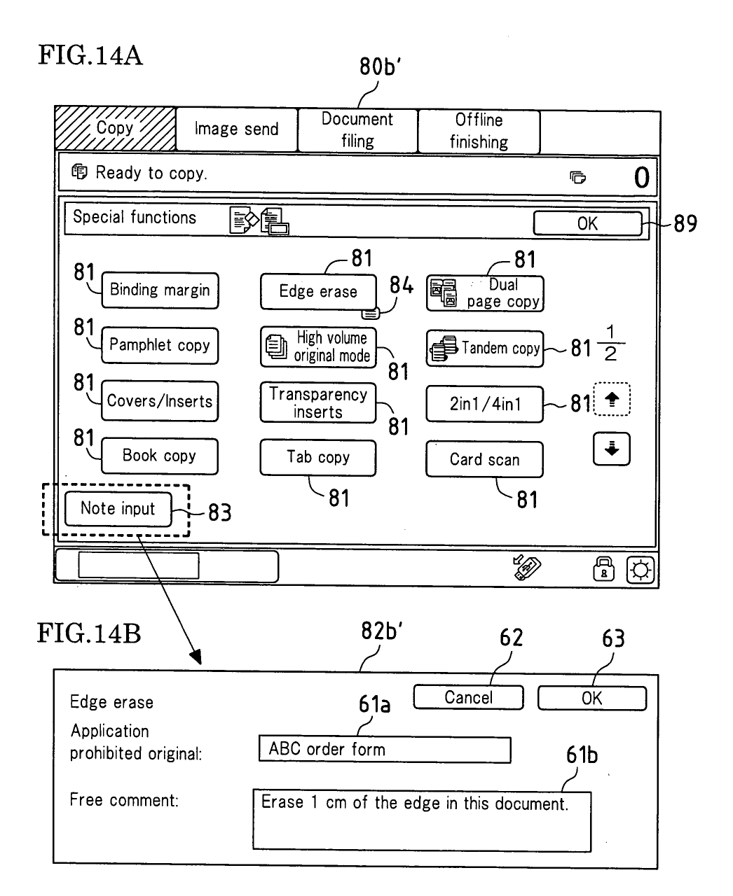

Note that the send function is executed by pressing the start key 107d in the operation panel 106 shown in FIG. 5A in a state in which the function execution key 81 is selected in the operation screen 80a for the image send function, and by pressing an OK key 89 in the operation screen 80a′ in a state in which the function execution key 81 is selected in the operation screen 80a′ for special functions, the screen moves to a screen for setting the edge erase function. This operation is the same as that in FIGS. 13A to 18B described later, and is therefore omitted from the description below.

The input control means configured by the control unit 101 may also be made capable of inputting comment information 82 into the operation screen 80a or 80a′ in the function execution mode.

Specifically, when an operation for outputting comment information 82 for function information displayed in the operation screen 80a or 80a′ of the display unit 108 has been performed (here, when the comment information display icon 84 is selected), the display control means may display the comment information 82 in the display unit 108, and afterward, when next an operation for inputting the comment information 82 has been performed, the input control means may execute an operation to input the comment information 82.

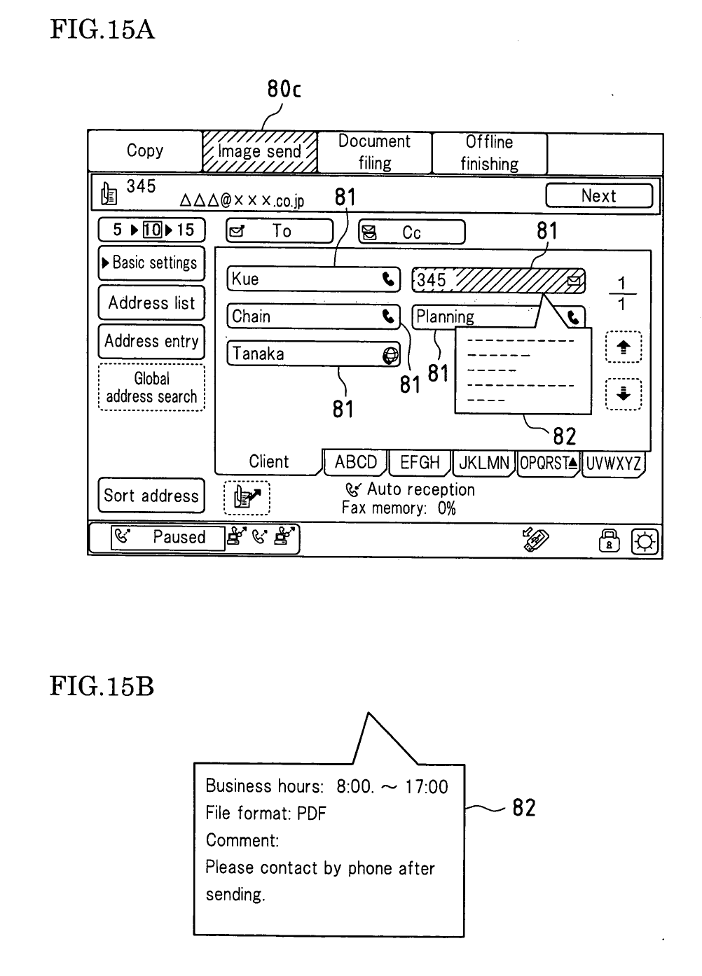

FIGS. 13A to 14B illustrate an example of an operation to input comment information 82 in the function execution mode.

FIG. 13A is a schematic diagram that shows another example of an operation screen displayed when the function selection key 71a has been pressed in the function operation screen 70 shown in FIG. 10. FIG. 13B is a schematic diagram that shows an example of a comment input screen displayed when a comment information input key (here, a note input key that is a software key) 83 has been pressed in the operation screen shown in FIG. 13A.

FIG. 14A is a schematic diagram that shows another example of an operation screen displayed when the special function key 108a has been pressed in the initial screen shown in FIG. 5B. FIG. 14B is a schematic diagram that shows an example of a comment input screen displayed when the comment information input key (here, a note input key that is a software key) 83 has been pressed in the operation screen shown in FIG. 14A.

As shown in FIGS. 13A and 14A, in the function execution mode, the display control means is made capable of displaying a function execution key 81 for executing various functions in the operation screen 80b or 80b′ of the display unit 108 such that the input of a selection is possible, and displaying the comment information display icon 84 for displaying that comment information 82 in the operation screen 80b or 80b′, such that the comment information is associated with the corresponding function execution key 81 and the input of a selection is possible and, also, displaying the note input key 83 for operating the input control means in the operation screen 80b or 80b′ such that the input of a selection is possible. Here, it is possible to display the comment information display icon 84 only when comment information 82 has been input (when comment information 82 exists).

When the comment information display icon 84 displayed in the operation screen 80b or 80b′ has been selected, the display control means is made capable of displaying, with respect to a function execution key 81 corresponding to that comment information display icon 84, comment information 82 for a function (here, a send function to recipient ‘345’ or an edge erase function) corresponding to the function execution key 81. Also, when the comment information display icon 84 displayed in the operation screen 80b or 80b′ has been selected, the display control means is made capable of displaying, with respect to a function execution key 81 corresponding to that comment information display icon 84, comment information 82 for a function corresponding to the function execution key 81. When next the note input key 83 has been selected, as shown in the comment input screen 82b or 82b′ in FIGS. 13B and 14B, the input control means is made capable of executing an operation to input the comment information 82 for the function that corresponds to that function execution key 81.

With this configuration, the comment information display icon 84 is displayed only when comment information 82 has been input, so it is possible for the user to easily recognize whether or not comment information 82 exists. In addition, it is possible to display comment information for the function information displayed in the operation screen 80b or 80b′ of the display unit 108 only when the user wants to confirm that information. Furthermore, in the function execution mode, after confirming the comment information 82 displayed when the comment information display icon 84 displayed in the operation screen 80b or 80b′ has been selected, the user can add to/update the comment information 82 in the comment input screen 82b or 82b′.

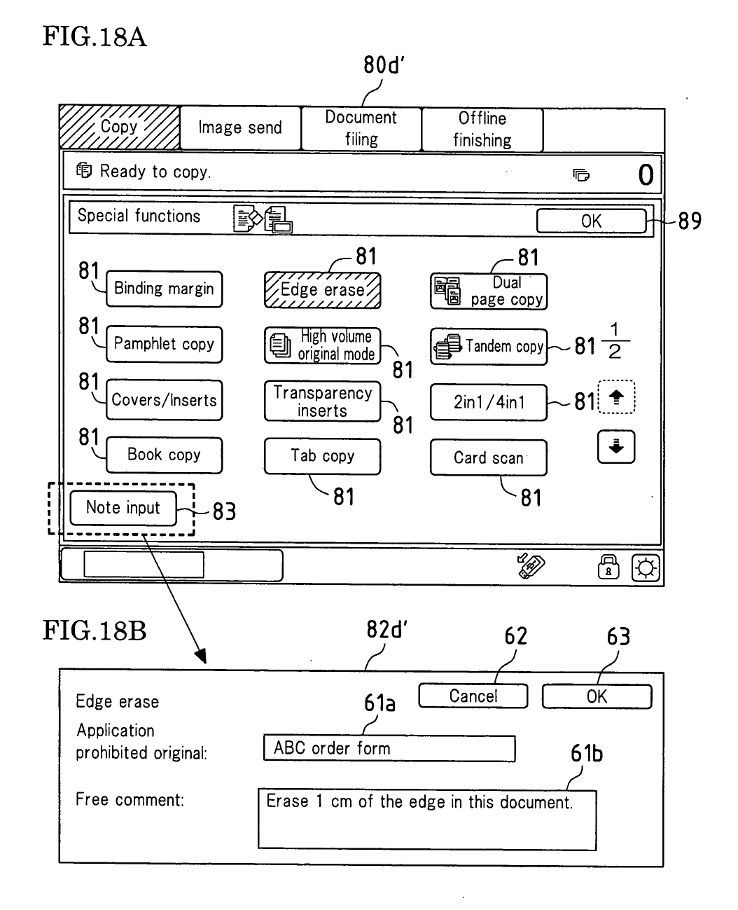

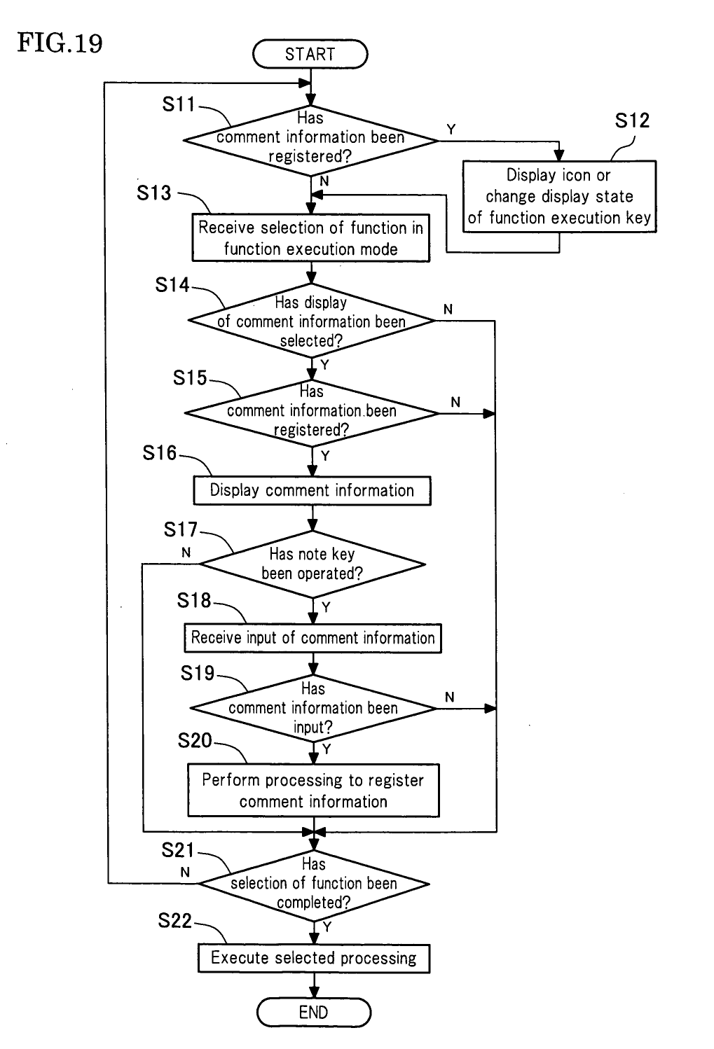

Note that when the cancel key 58 or 62 respectively disposed in the upper part of the comment input screen 82b or 82b′ has been pressed, a process to return to the operation screen 80b or 80b′ shown in FIGS. 13A and 14A is performed, and when the OK key 59 or 63 has been pressed, the input content in the comment input screen 82b or 82b′ is fixed, and a process to return to the operation screen 80b or 80b′ shown in FIGS. 13A and 14A is performed. This operation is the same as that in FIGS. 17A to 18B, described later, and is therefore omitted from the description below.

### Regarding Second Embodiment

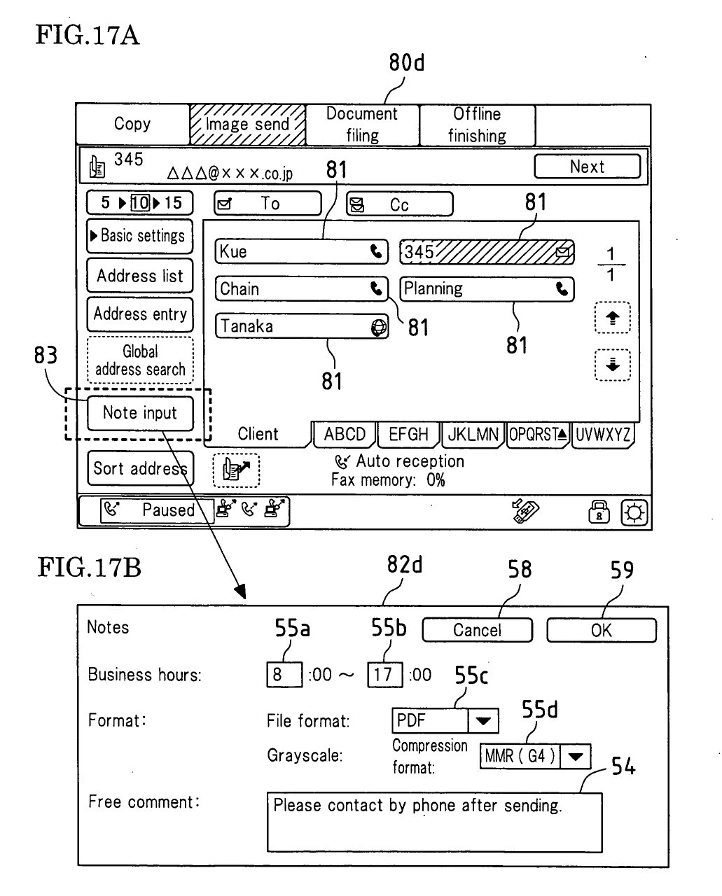

FIG. 15A is a schematic diagram that shows still another example of an operation screen displayed when the function selection key 71a has been pressed in the function operation screen 70 shown in FIG. 10. FIG. 15B shows an enlarged view of comment information 82 in FIG. 15A. FIG. 16A is a schematic diagram that shows still another example of an operation screen displayed when the special function key 108a has been pressed in the initial screen shown in FIG. 5B. FIG. 16B shows an enlarged view of comment information 82 in FIG. 16A.

In the second embodiment, as shown in FIGS. 15A to 16B, when comment information 82 has been input for an operation key 81 in an operation screen 80c or 80c′ by the input means, the display control means configured by the control unit 101 makes the display state of the operation key 81 different from the display state in which comment information 82 is not input for the operation key 81 (here, the color is changed), and when a function information operation key 81 (here, information on the image send function or a special function) displayed in the operation screen (here, the address book screen 80c or the special function settings screen 80c′) of the display unit 108 has been selected, the display control means displays comment information 82 for the function information in the display unit 108.

Specifically, in the function execution mode, the display control means is made capable of displaying a function execution key 81 (an example of an operation key and, here, a software key used to designate a recipient and a software key used to set edge erase) for executing various functions in the operation screen 80c or 80c′ of the display unit 108 such that the input of a selection is possible. The display control means is made capable of establishing an execution suspended state (for example, a selection display state in which the display of the function execution key 81 is changed to a display indicating a suspended state such as a reversed display, and execution is suspended) when a function execution key 81 displayed in the operation screen 80c or 80c′ has been selected, and also displaying, with respect to that function execution key 81, comment information 82 for the function (here, the send function to recipient ‘345’ or the edge erase function) corresponding to the function execution key 81.

With this configuration, when comment information 82 has been input, the display state of a function execution key 81 is made different from the display state in which comment information 82 is not input, which enables the user to easily recognize whether or not comment information 82 exists. In addition, it is possible to display comment information 82 for a function execution key 81 displayed in the operation screen 80c or 80c′ of the display unit 108 only when the user selects the function execution key 81. Furthermore, comment information 82 can be displayed when a function execution key 81 displayed in the operation screen 80c or 80c′ has been selected; thus, as the space to display comment information 82, only the space to display the selected comment information 82 is necessary, and to that extent, it is possible to save space for the display space of the operation screen 80c or 80c′ and, also, comment information 82 for the function to be executed (here, the image send function or the edge erase function) can be uniquely specified. As a result of this, it is possible to reliably inform the user of the comment information 82 for the function to be executed.

The input control means configured by the control unit 101 may be capable of inputting comment information 82 in the operation screen 80c or 80c′ in the function execution mode.

Specifically, when a function execution key 81 displayed in the operation screen 80c or 80c′ of the display unit 108 has been selected, the display control means may display comment information 82 for the function execution key 81 in the display unit 108. After that, when next an operation for inputting the comment information 82 has been performed, the input control means may execute an operation to input the comment information 82.

FIGS. 17A to 18B illustrate an example of an operation to input comment information 82 in the function execution mode.

FIG. 17A is a schematic diagram that shows still another example of an operation screen displayed when the function selection key 71a has been pressed in the function operation screen 70 shown in FIG. 10. FIG. 17B is a schematic diagram that shows an example of a comment input screen displayed when the comment information input key (here, note input key) 83 has been pressed in the operation screen shown in FIG. 17A.

FIG. 18A is a schematic diagram that shows still another example of an operation screen displayed when the special function key 108a has been pressed in the initial screen shown in FIG. 5B. FIG. 18B is a schematic diagram that shows an example of a comment input screen displayed when the comment information input key (here, note input key) 83 has been pressed in the operation screen shown in FIG. 18A.

As shown in FIGS. 17A and 18A, in the function execution mode, the display control means is made capable of displaying a function execution key 81 for executing various functions in operation screen 80d or 80d′ of the display unit 108 such that the input of a selection is possible, and also displaying the note input key 83 for executing the input control means in the operation screen 80d or 80d′ such that the input of a selection is possible. Further, when comment information 82 has been input for a function execution key 81, the display control means is made capable of making the display state of the operation key 81 different from the display state in which comment information 82 is not input for the operation key 81 (here, the color is changed). When a function execution key 81 displayed in the operation screen 80d or 80d′ has been selected, the display control means is made capable of establishing an execution suspended state (a selection display state in which execution is suspended) and also displaying, with respect to that function execution key 81, comment information 82 for the function (here, the send function to recipient ‘345’ or the edge erase function) corresponding to the function execution key 81. Also, when a function execution key 81 displayed in the operation screen 80d or 80d′ has been selected, the display control means is made capable of establishing an execution suspended state and also displaying, with respect to that function execution key 81, comment information 82 for the function corresponding to the function execution key 81. When next the note input key 83 has been selected, as shown in comment input screens 82d and 82d′ in FIGS. 17B and 18B, the input control means is made capable of executing an operation to input comment information 82 for the function that corresponds to that function execution key 81.

With this configuration, in the case in which comment information 82 has been input, the display state of the function execution key 81 is made different from the display state when comment information 82 is not input, which enables the user to easily recognize whether or not comment information 82 exists. In addition, it is possible to display comment information 82 for a function execution key 81 displayed in the operation screen 80d or 80d′ of the display unit 108 only when the user selects the function execution key 81. Furthermore, in the function execution mode, after confirming comment information 82 displayed when a function execution key 81 displayed in the operation screen 80d or 80d′ has been selected, the user can add to/update the comment information 82 in the comment input screen 82d or 82d′.

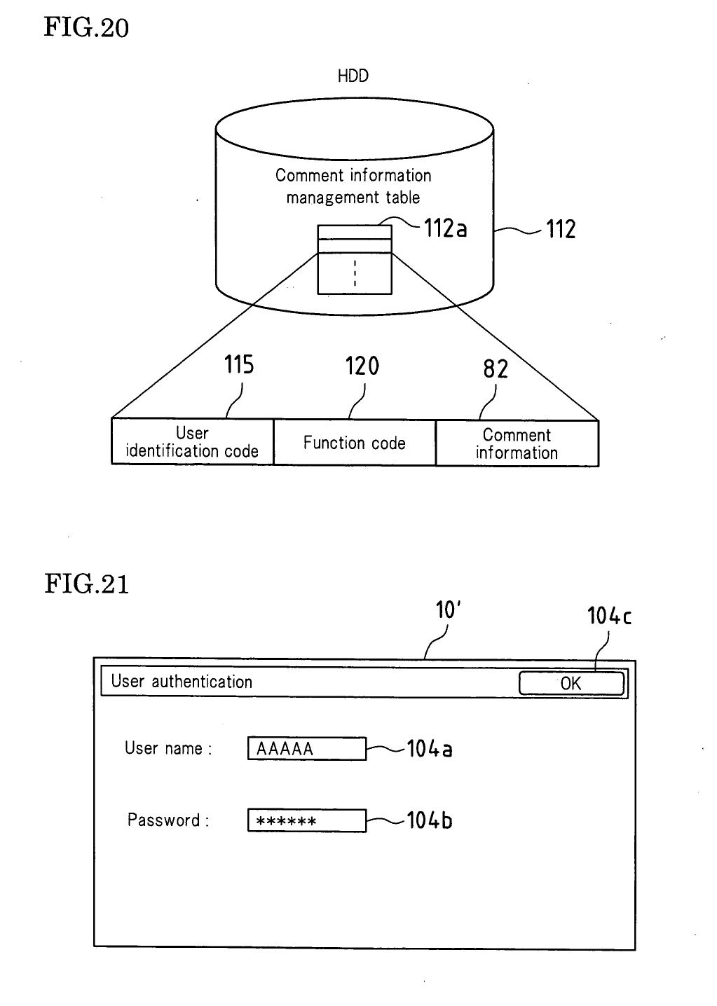

Next, in the function execution mode, an example of the operational flow of processing for displaying and inputting comment information 82 for function information displayed in an operation screen will be described with reference to FIG. 19.

FIG. 19 is a flowchart that shows an example of processing for displaying and inputting comment information 82 for function information displayed in an operation screen in the function execution mode.

In the processing shown in FIG. 19, first, it is determined whether or not comment information 82 has been registered (Step S11). When comment information 82 has not been registered (Step S11 N), the processing proceeds to Step S13. On the other hand, when comment information 82 has been registered (Step S11: Y), the comment information display icon 84 is displayed in the first embodiment, and the display state of the function execution key 81 is changed in the second embodiment (Step S12), and then the processing proceeds to Step S13. In Step S13, selection of a function (for example, a send function using an address book or various print functions) in the function execution mode is received.

Next, when the display of comment information 82 has not been selected (Step S14: N), the processing proceeds to Step S21. On the other hand, when the display of comment information 82 has been selected (Step S14: Y), it is determined whether or not the comment information 82 has been registered (Step S15). When the comment information 82 has not been registered (Step S15: N), the processing proceeds to Step S21. On the other hand, when the comment information 82 has been registered (Step S15: Y), the comment information 82 is displayed (Step S16).

Then, it is determined whether or not the note input key 83 has been operated (Step S17). When the note input key 83 has not been operated (Step S17: N), the processing proceeds to Step S21. On the other hand, when the note input key 83 has been operated (Step S17: Y), input of the comment information 82 is received (Step S18).

Next, it is determined whether or not the comment information 82 has been input (Step S19). When the comment information 82 has not been input (Step S19: N), the processing proceeds to Step S21. On the other hand, when the comment information 82 has been input (Step S19: Y), the comment information 82 is registered in the comment information management table 112a, being associated with the corresponding function information 130 (Step S20), and the processing proceeds to Step S21.

Then, it is determined whether or not the selection of a function in the function execution mode has been completed (Step S21). When the selection of a function has not been completed (Step S21: N), the processing proceeds to Step S13. On the other hand, when the selection of a function has been completed (Step S21: Y), the processing proceeds to Step S22. In Step S22, the selected function is executed (here, sending to recipient ‘345’ using an address book or setting edge erase), and then the processing ends.

Incidentally, here, comment information 82 is displayed so as to conceal part of another function execution key 81, and in this case, the problem occurs in which the comment information 82 becomes an obstruction and the other function execution key 81 cannot be operated. To address this problem, as already described above in connection with the system settings mode, the display control means is configured to display the comment information 82 only for a predetermined fixed time period from the start of display. By doing so, even if part of another function execution key 81 is concealed by comment information 82, that other function execution key 81 can be selected after the passage of a predetermined time period. Also, comment information 82 may be displayed in an open space other than the display location of the function execution key.

Also, the input control means is made capable of inputting a display condition when the display control means displays comment information 82. Here, as shown in FIG. 7C, this display condition involves the selection of a comment display time and a comment display condition, i.e., the selection of whether to display the comment information 82 with the comment information display icon 84 as shown in FIGS. 11A to 14B (when selecting a comment display icon in the first embodiment), or to display the comment information 82 with the function execution key 81 as shown in FIGS. 15A to 18B (when selecting the function execution key in the second embodiment).

### Other Examples of First and Second Embodiments

Next, the digital multifunction peripheral 100 according to the first embodiment or second embodiment may be provided with a user authentication unit that performs user authentication; an input means that inputs comment information into the operation screen of the display unit 108 for each user that has been authenticated by the user authentication unit; and a display control means that displays in the operation screen of the display unit 108, among comment information that has been input by the input means, comment information for a user that has been authenticated by the user authentication unit. The same elements in this configuration as the elements described above are given the same reference numerals, and mainly the different points will be described below.

This digital multifunction peripheral 100 is further provided with an authentication information storage unit that stores user authentication information. Note that in this embodiment, the authentication information storage unit is configured with the authentication code management table 105c of the management unit 105.

The control unit 101 is configured so as to be provided with a user authentication means that performs user authentication using user authentication information stored in the authentication information storage unit (hereinafter, referred to as the authentication code management table 105c); an input control means that inputs comment information for function information (here, function information stored in the function information management table 105d) displayed in an operation screen of the display unit 108 for each user that has been authenticated by the user authentication means; a storage control means that stores comment information that has been input by the input control means in the comment information management table 112a for each user, such that the comment information is associated with the corresponding function information, a read control means that reads out the comment information for each user that has been stored in the comment information management table 112a by the storage control means along with the corresponding function information from the comment information management table 112a; and a display control means that displays in an operation screen of the display unit 108, among the comment information that has been read out from the comment information management table 112a by the read control means, comment information for a user that has been authenticated by the user authentication means such that the comment information is associated with the corresponding function information.

According to the digital multifunction peripheral 100 of the first embodiment or second embodiment of the present invention, user authentication is performed, and as the comment information to be displayed in the operation screen of the display unit 108, information useful to the authenticated user (for example, a comment “erase 1 cm of the edge” in the case of copying a document such as an order form, or a comment “contact by phone after sending” in the case of sending a document) is input, and the comment information 82 for that user is displayed in the operation screen. By doing so, when the user performs an operation based on display information displayed on the operation screen of the display unit 108, information useful for that operation can only easily be acquired by that user, so it is possible to reduce input errors and improve operability. Furthermore, because the comment information for the authenticated user is displayed in the operation screen, it is possible not to display information that is unnecessary to another user or information that should not be provided to another user (particularly information that should be kept confidential).

Accordingly, even if a plurality of users have input comment information for the function information displayed in the operation screen of the display unit 108, by displaying the comment information for the authenticated user in the display unit 108, the comment information displayed in the operation screen can be designated as comment information for the authenticated user, so it is possible to avoid display complications in which this comment information is displayed intermingled with the comment information for another user.

Furthermore, when comment information 82 has been input for an operation key 81, the icon 84 giving notification that comment information has been input is displayed in the operation screen in the first embodiment, and the display state of the operation key 81 is made different (for example, the color is changed) in the second embodiment, which enables the user to easily recognize that comment information 82 has been input for the operation key 81.

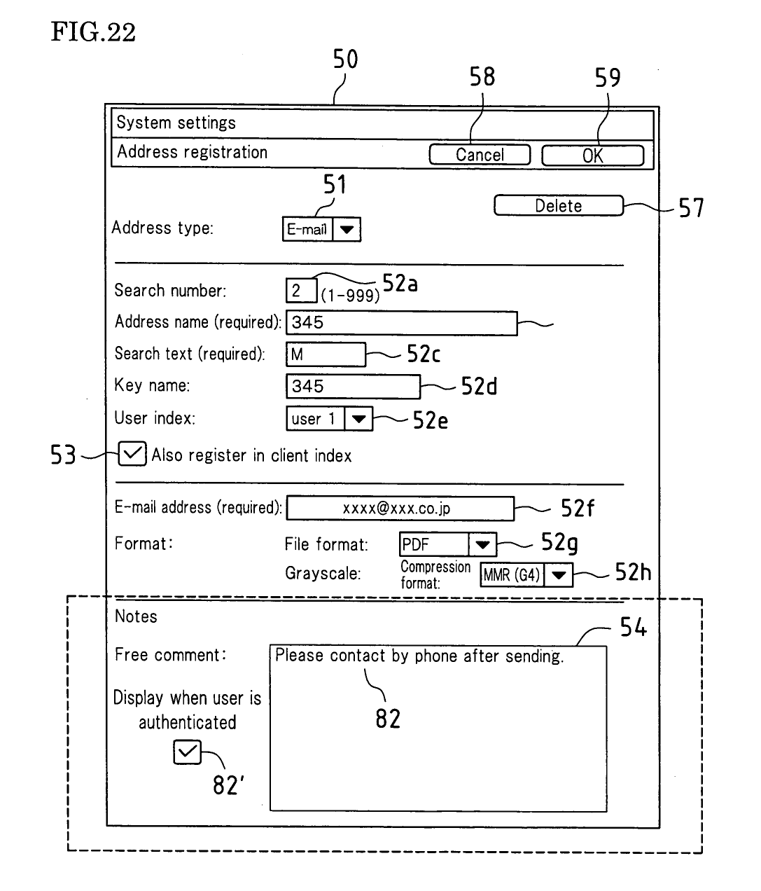

FIG. 20 is a schematic diagram that shows another example of the data structure of the comment information management table 112a. As shown in FIG. 20, comment information 82 is stored in the comment information management table 112a, being associated with the function code 120 for each user identification code 115, which identifies a user. Thus, the comment information 82 can be associated with the corresponding function information 130 for each user (each user identification code 115).

### (System Settings Mode)

In the system settings mode, it is possible to set whether or not to perform user authentication. Here, user authentication is set, and so login is performed when using the digital multifunction peripheral 100.

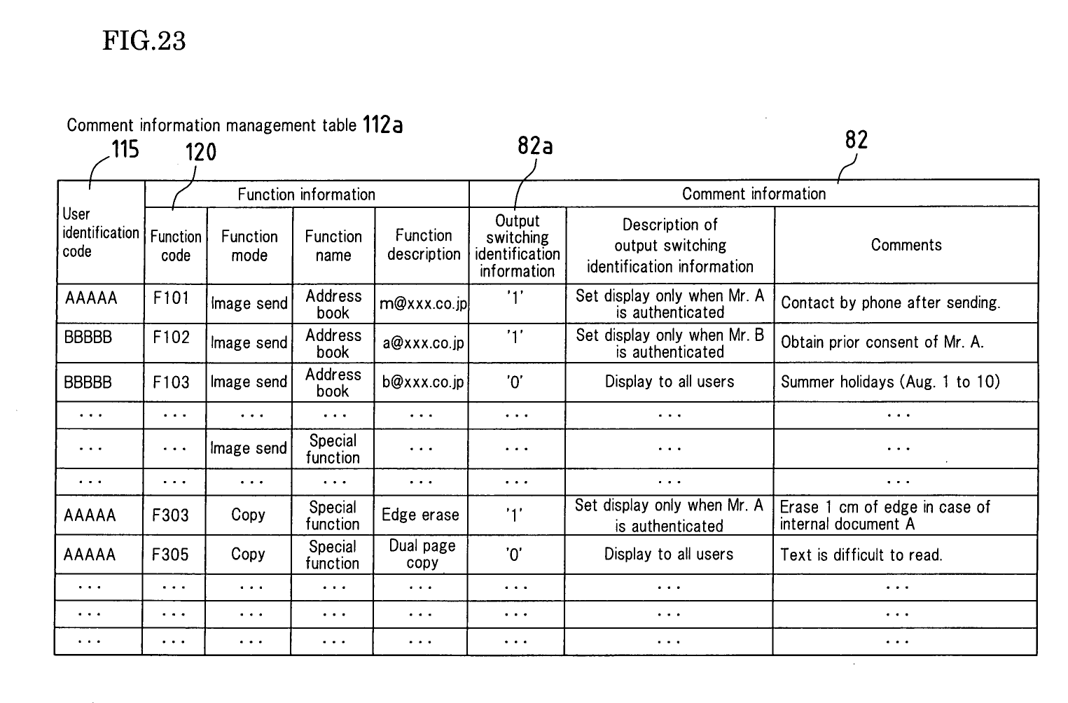

FIG. 21 shows a login screen 10′ displayed in the display unit 108 when performing user authentication.

As shown in FIG. 21, the control unit 101 is made capable of inputting a user name (user identification code 115) and a password in the login screen 10′ (specifically, input boxes 104a and 104b), and when a user name and a password are input in the login screen 10′ and fixed (specifically, when an OK key 104c is pressed), it is possible to perform user authentication by comparing these to a pre-registered (specifically, pre-stored in the authentication code management table 105c) user name and password.

In the first and second embodiments of the present invention, in the system settings mode, the input control means configured by the control unit 101 inputs comment information for a function information operation key 81 displayed in the operation screen for each authenticated user.

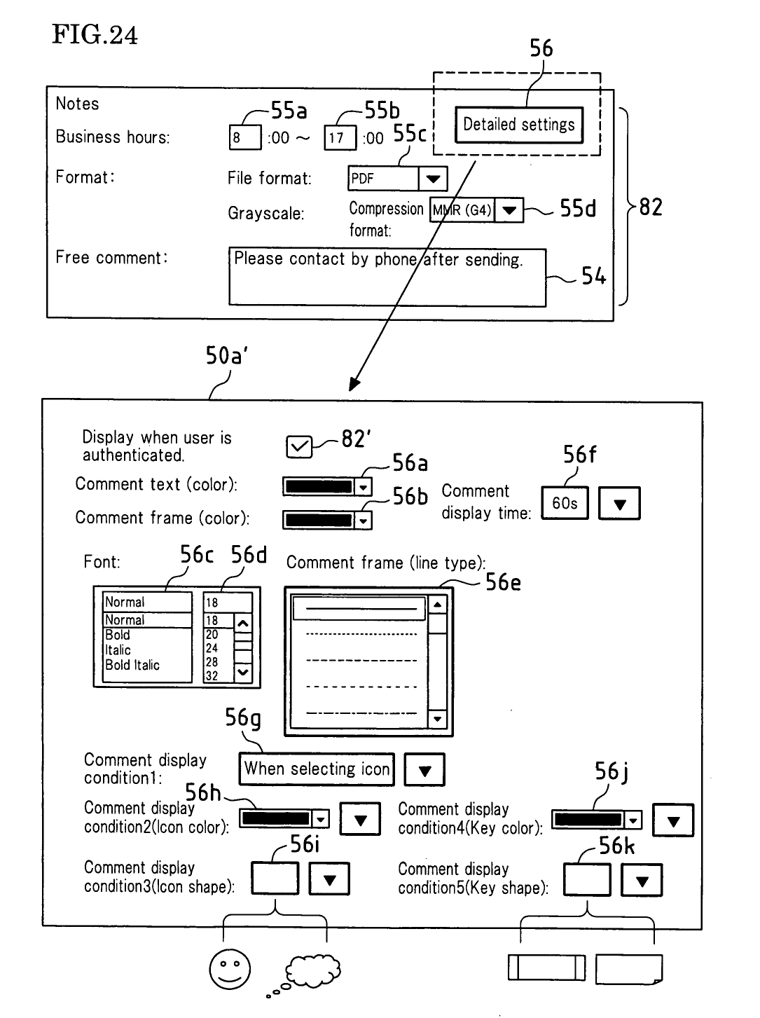

FIG. 22 is a schematic diagram that shows another example of a screen displayed in the display unit 108 when setting one-touch key assignment.

When the one-touch registration key 41 has been pressed in the registration content settings screen 40 shown in FIG. 6C, the address settings screen 50 shown in FIG. 22 is displayed in the display unit 108 instead of the registration content settings screen 40.

FIG. 22 shows another example of an address settings screen for assigning a one-touch key to an electronic mail address shown in FIG. 7A.

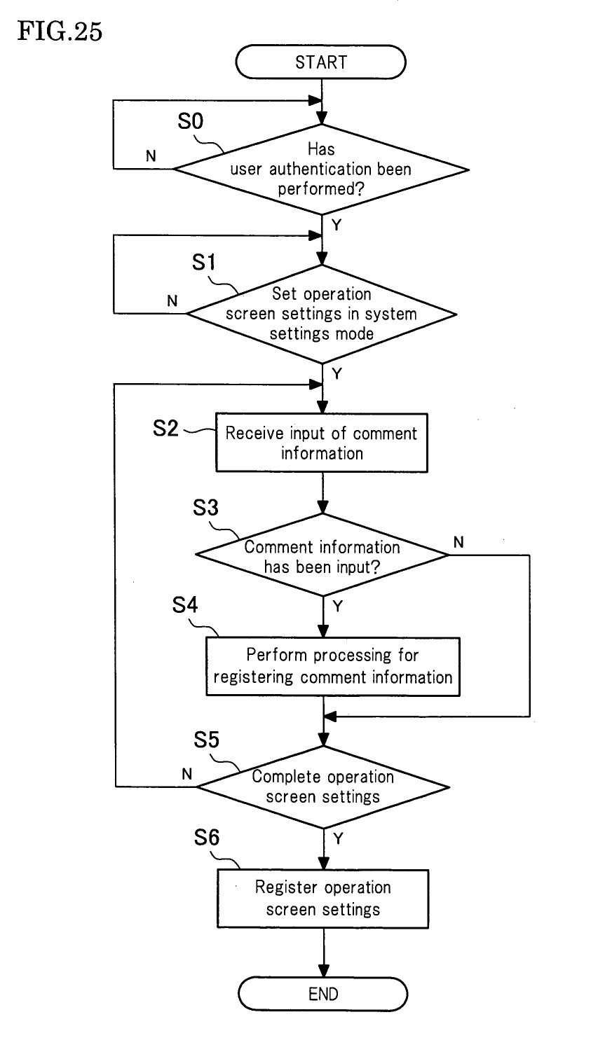

In the first and second embodiments of the present invention, comment information 82 includes output switching identification information 82a (see FIG. 23 described later), which identifies whether to display the comment information 82 only when a user for the comment information 82 is authenticated, or to display the comment information 82 to all users. Also, the input control means configured by the control unit 101 is capable of inputting output switching identification information 82a to comment information 82.

FIG. 23 is a schematic diagram that shows a detailed view of part of the comment information management table 112a shown in FIG. 20.

Specifically, as shown in FIG. 23, the input control means is made capable of, when displaying comment information 82 only when a user for the comment information 82 is authenticated, selecting and inputting an authentication output code (here, ‘1’) in the output switching identification information 82a, and when displaying the comment information 82 to all users, selecting and inputting an all user output code (here, ‘0’) in the output switching identification information 82a.

The display control means configured by the control unit 101 is capable of switching between displaying comment information 82 only when a user for the comment information 82 is authenticated, and displaying the comment information 82 to all users, based on the output switching identification information 82a, which has been input by the input control means.

Specifically, the display control means is made capable of displaying the comment information 82 only when a user is authenticated for that comment information 82 in a case in which an authentication output code (here, ‘1’) has been selected and input in the output switching identification information 82a in the comment information 82. On the other hand, the display control means is made capable of displaying the comment information 82 to all users in a case in which an all user output code (here, ‘0’) has been selected and input in the output switching identification information 82a in the comment information 82.

With this configuration, by selecting the all user output code (here, ‘0’) for the output switching identification information 82a in the comment information 82, it is possible to provide the comment information 82 to all users. Thus, it is possible to provide the comment information 82 also to users other than an authenticated user.

In this example, a selection key (here, a check box) 82′ used to set whether to use authenticated user display or all user display is disposed in the address settings screen 50 shown in FIG. 22. When the selection key 82′ is selected (here, checked), the authentication output code (here, ‘1’) is input in the output switching identification information 82a. On the other hand, when the selection key 82′ is not selected (here, not checked), the all user output code (here, ‘0’) is input in the output switching identification information 82a. The selection key (here, a check box) 82′ is disposed in the screens shown in FIGS. 7B, 7C, 8, 13B, 14B, 17B, and 18B, and the key is not shown in all figures and a description thereof is omitted here.

Also, as for setting display conditions when displaying comment information 82 in the display unit 108, setting a display condition regarding the manner of display for comment information in the display unit 108 further includes setting whether or not to use the output switching identification information 82a here.

In the first embodiment, here, the display control means is made capable of changing the color or/and furthermore the shape of the comment information display icon 84 to be displayed in the operation screen for each user that has been authenticated by the user authentication means.

On the other hand, in the second embodiment, here, when the input means has input comment information for a function execution key 81, the display control means is made capable of changing the color or/and furthermore the shape of the function execution key 81 to be displayed in the operation screen for each user that has been authenticated by the user authentication means.

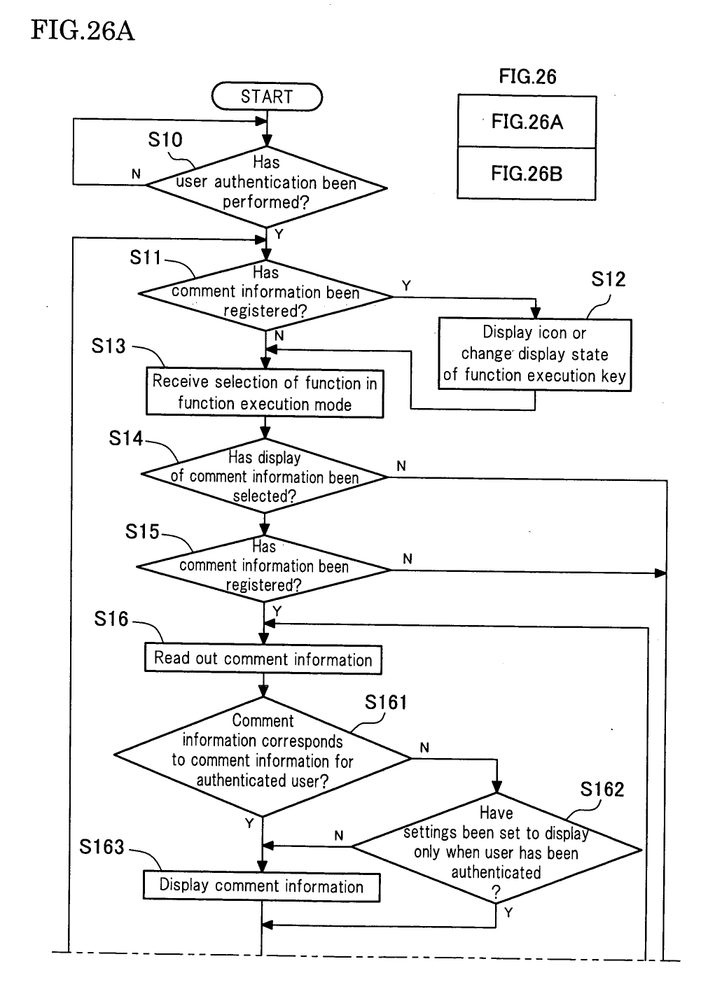

FIG. 24 is a schematic diagram that shows another example of a screen shown in FIG. 7C. In the comment input box shown in FIG. 24, by pressing the detailed settings key 56, detailed settings for the comment information 82 can be set.

Here, the input control means configured by the control unit 101 inputs, to the comment information 82 in addition to information on visual modification processing, information regarding the color and the shape of the comment information display icon 84 for each user that has been authenticated by the user authentication means in the first embodiment, and information regarding the color and the shape of the function execution key 81 for each user that has been authenticated by the user authentication means in the second embodiment. The display control means configured by the control unit 101 displays, in addition to performing processing to display the comment information 82, on which the input control means has performed visual modification processing, the comment information display icon 84 for each user that has been authenticated by the user authentication means based on the color information and the shape information input by the input control means in the first embodiment and the function execution key 81 for each user that has been authenticated by the user authentication means based on the color information and the shape information input by the input control means in the second embodiment.

In this example, comment information 82 includes information regarding the color and the shape of the comment information display icon 84, and the color and the shape of the function execution key 81 in addition to information on visual modification processing. Further, designation of the color and the shape of the comment information display icon 84 and designation of the color and the shape of the function execution key 81 are respectively input in comment input boxes 56h to 56k.

Note that the selection key (here, a check box) 82′ used to set whether to use authenticated user display or all user display is disposed in a detailed settings screen 50a′. Further, a setting to be input in the comment input box 56g for a display condition regarding the manner of display for the comment information in the display unit 108 is, for example, either to display when selecting a function execution key or to display when selecting a comment display icon, or to set whether or not to use the output switching identification information 82a.

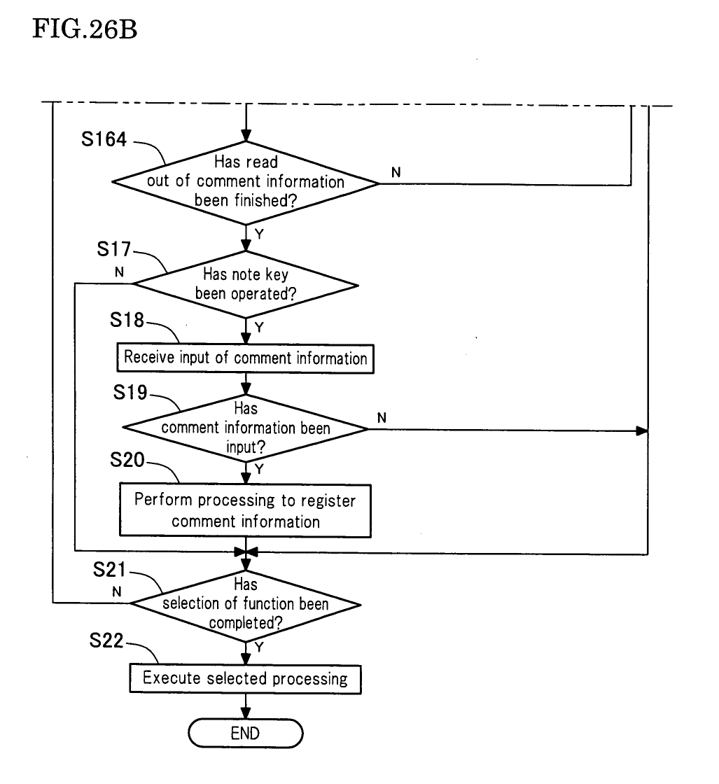

Next is a description of the operational flow of processing for inputting such comment information 82 for a function information operation key 81 displayed in an operation screen in the system settings mode, with reference to FIG. 25.

FIG. 25 is a flowchart that shows another example of processing for inputting comment information 82 for function information displayed in an operation screen in the system settings mode.

In the processing shown in FIG. 25, first, user authentication is performed in the login screen 10′ (Step S0). Specifically, the input of a user name (user identification code 115) and a password in the login screen 10′ is awaited (Step S0: N), user authentication is performed by the user name and password being input (Step S0: Y), and then the processing proceeds to Step S1. Thereafter, in Step S4, comment information 82 is registered in the comment information management table 112a, being associated with the corresponding function information 130, for each user identification code 115.

### (Function Execution Mode)

In the first and second embodiments of the present invention, in the function execution mode, the display control means configured by the control unit 101 displays comment information 82 for a user that has been authenticated, such that the comment information is associated with the corresponding function information operation key 81 from among the comment information 82, which has been input by the input control means.

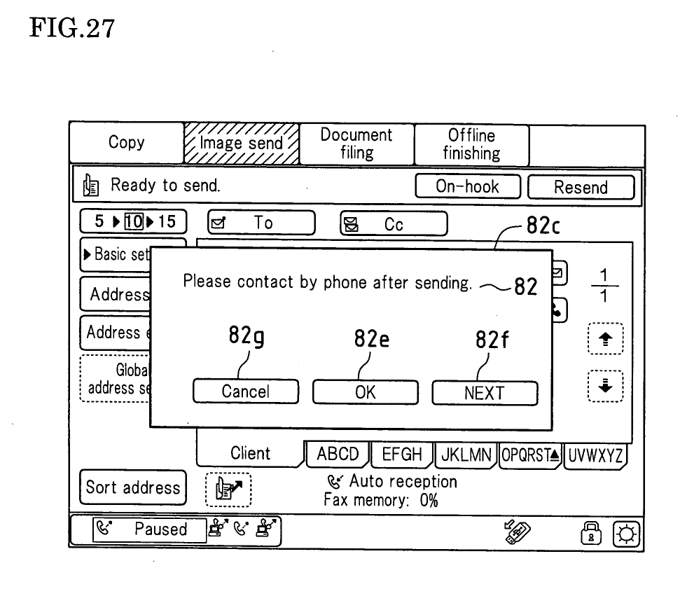

Next is a description of another example of an operational flow of processing for displaying and inputting comment information 82 for function information displayed in an operation screen in the function execution mode, with reference to FIG. 26.

FIG. 26 is a flowchart that shows another example of processing for displaying and inputting comment information 82 for function information displayed in an operation screen in the function execution mode for each user. Descriptions of the same processing as that shown in FIG. 19 will be omitted below, and mainly the different points will be described.

In the processing shown in FIG. 26, first, user authentication is performed in a login screen (Step S10). Specifically, the input of a user name (user identification code 115) and a password in the login screen is awaited (Step S10: N), user authentication is performed by the user name and password being input (Step S10: Y), and then the processing proceeds to Step S13. In Step S13, the selection of a function (for example, a send function using an address book or various print functions) in the function execution mode is received.

Then, in Step S16, comment information 82 is read out from the comment information management table 112a.

Next, it is determined whether or not the comment information 82, which has been read out from the comment information management table 112a, is comment information for the authenticated user (user identification code 115) (Step S161), and when the read comment information is comment information for the authenticated user (user identification code 115), the processing proceeds to Step S163. On the other hand, when the read comment information is not comment information for the authenticated user (user identification code 115), it is determined whether or not the output switching identification information 82a has been set so as to display comment information only when a user has been authenticated (whether the output switching identification information 82a is set to an authentication output code) (Step S162). When the output switching identification information 82a is set to an authentication output code (here, ‘1’), the processing proceeds to Step S164. On the other hand, when the output switching identification information 82a is not set to an authentication output code (here, ‘1’), i.e., when the output switching identification information 82a is set to an all user output code (here, ‘0’), the processing proceeds to Step S163.

Next, in Step S163, the comment information 82 is displayed, and in Step S164, it is determined whether or not reading of the comment information 82 from the comment information management table 112a is finished. When reading of the comment information 82 is not finished (Step S164: N), the processing proceeds to Step S16. On the other hand, when reading of the comment information 82 is finished, the processing proceeds to Step S17.

Then, in Step S20, the comment information 82 is registered in the comment information management table 112a, being associated with the corresponding function information 130 for each user identification code 115.

Note that as for a display condition for displaying comment information 82 by the display control means, the comment display condition herein involves the selection of whether to display the comment information 82 with the comment information display icon 84 (when selecting the comment display icon in the first embodiment) or to display the comment information 82 with the function execution key 81 (when selecting the function execution key in the second embodiment) or, alternatively, the selection of whether or not to use the output switching identification information 82a. Note that when not using the output switching identification information 82a, Step S162 in the flowchart in FIG. 26 described above can be omitted.

According to the digital multifunction peripheral 100 having such a configuration, even when comment information is displayed intermingled with the comment information for another user, by changing the color or shape of the comment information display icon 84 for each user authenticated by the authentication means in the first embodiment, or by changing the color or shape of the function execution key 81 for each user authenticated by the authentication means in the second embodiment, it is possible to easily distinguish the user's own comment information.

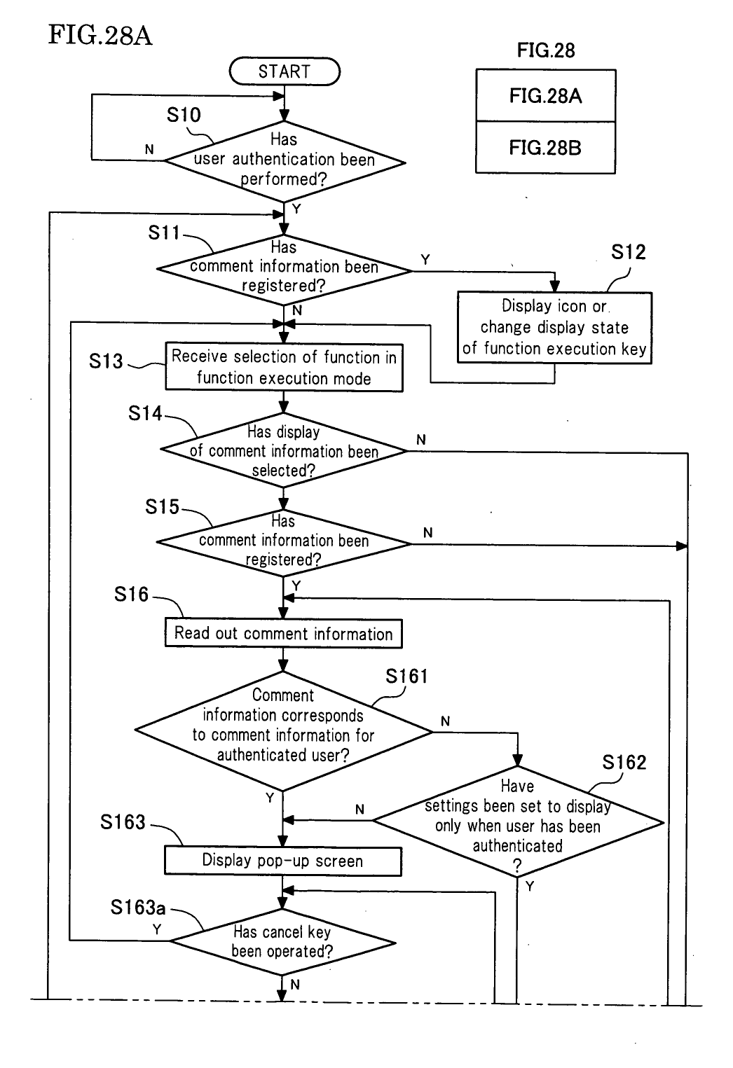

In the first and second embodiments of the present invention, when it is detected that the comment information display icon 84 has been selected in the first embodiment, or it is detected that the function execution key 81 has been selected in the second embodiment, the display control means may display the content of comment information 82 in the operation screen using a pop-up screen 82c. Specifically, when displaying the pop-up screen 82c, the display control means may simultaneously display an instruction key 82e (see FIG. 27 described later) used to give instructions to start an operation to process a function corresponding to the function execution key 81.

FIG. 27 shows an example of a case in which when sending image data by electronic mail, comment information 82 and also the instruction key (here, the OK key) 82e used to give instructions to start an operation to process a function corresponding to the function execution key 81 are simultaneously displayed using the pop-up screen 82c on the operation screen.

In the example shown in FIG. 27, the screen returns to the pervious screen by pressing a cancel key 82g, a processing operation is instructed to start (specifically, the destination for an electronic mail is selected) by pressing the OK key 82e, and the following comment information 82 is displayed using a pop-up screen by pressing a NEXT key 82f. Here, the same operations can be performed in the case in which comment information 82 is displayed in the operation screen using the pop-up screen 82c when executing the edge erase function; thus, such a case is not shown in the figures, and a description thereof is omitted here. Further, such a configuration in which a pop-up screen is displayed can also be applied to an operation screen shown in FIGS. 11A to 18B.

Note that in the above case, as for a display condition when displaying comment information 82 in the display unit 108, a comment display time can be a pop-up display time.

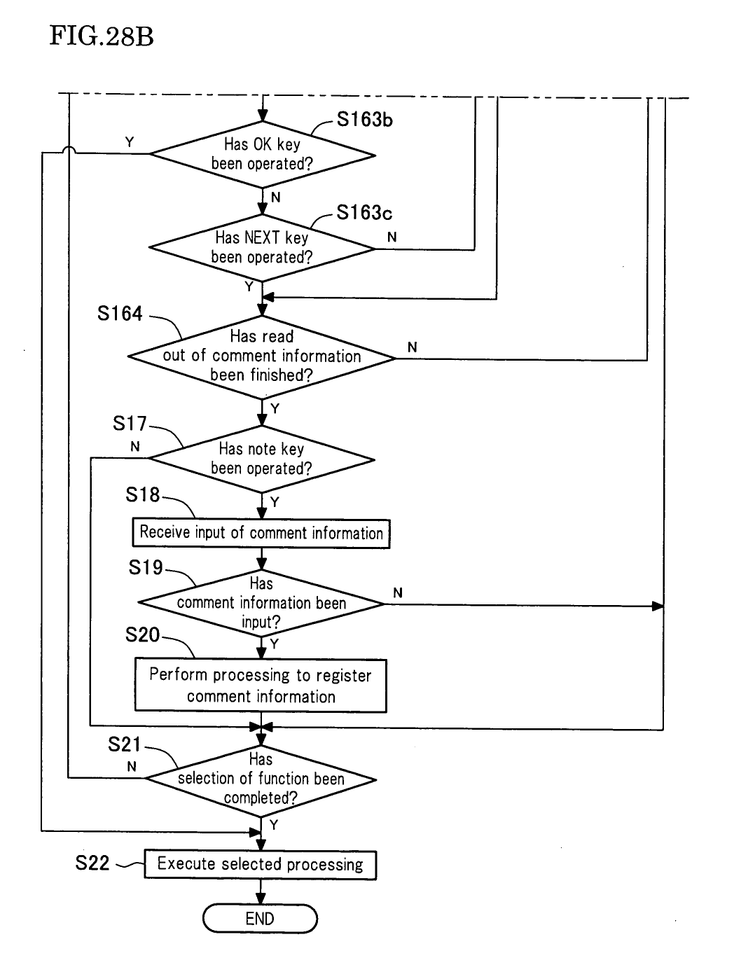

FIG. 28 is a flowchart that shows processing for displaying the content of comment information 82 in the operation screen using the pop-up screen 82c, in the flowchart shown in FIG. 26. Below, description of the same processing as that shown in FIG. 26 is omitted, and mainly the different points will be described.

In the processing shown in FIG. 28, the pop-up screen 82c is displayed in Step S163, and it is determined whether or not the cancel key 82g has been operated (Step S163a). If the cancel key 82g has not been operated (Step S163a :N), the processing proceeds to Step S163b. On the other hand, if the cancel key 82g has been operated (Step S163a :Y), the processing proceeds to Step S13. Next, if it is determined that the cancel key 82g has not been operated in Step S163a, it is determined whether or not the OK key 82e has been operated (Step 163b). If the OK key 82e has not been operated (Step S163b :N), the processing proceeds to Step S163c. On the other hand, if the OK key 82e has been operated (Step S163b :Y), the processing proceeds to step S22. Further, if it is determined that the OK key 82e has not been operated in Step S163b, it is determined whether or not the NEXT key 82f has been operated (Step S163c). If the NEXT key 82f has not been operated (Step S163c :N), the processing proceeds to Step S163a. On the other hand, if the NEXT key 82f has been operated (Step S163c :Y), the processing proceeds to Step S164. Note that here, if a state in which the keys 82g, 82e, and 82f are not operated is maintained, the display of the pop-up screen 82c is finished after the comment display time (a pop-up display time) that was set has elapsed (not shown in FIG. 28), and then the processing proceeds to Step S164.

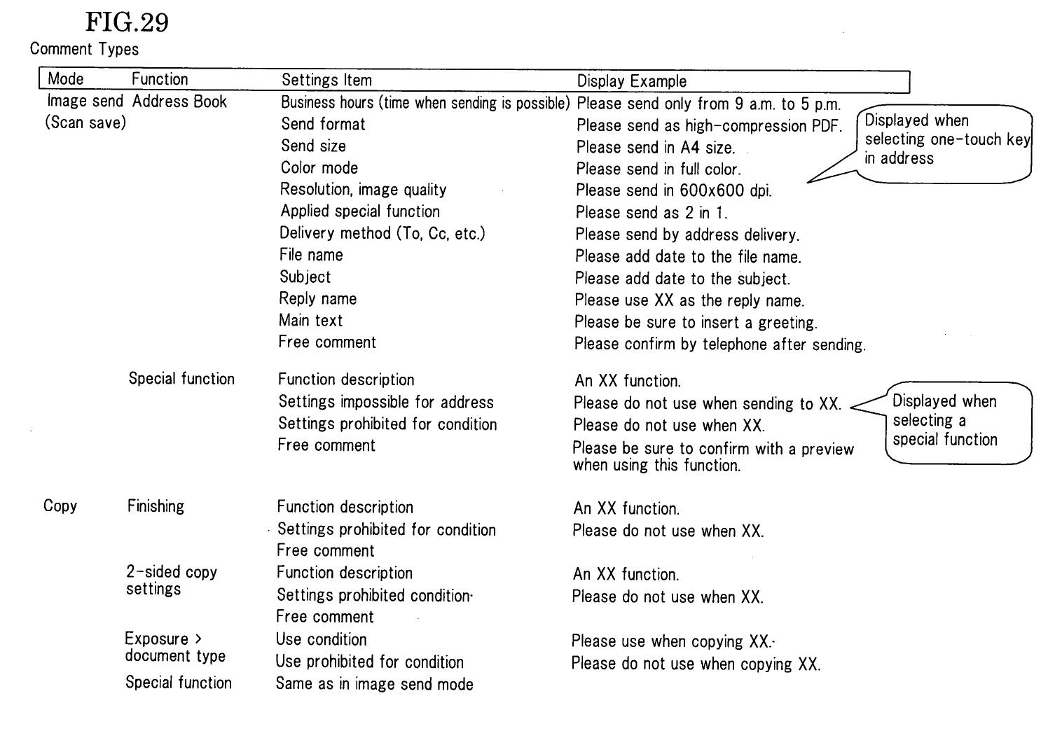

In the above description, the operation screen of the image send function and the operation screen of the edge erase function were given as examples and described, but it goes without saying that the same operations can also be performed in another operation screen. FIG. 29 shows a list of comment information that is input in the operation screens of various functions (examples of comments for setting items of various functions).

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. An image forming apparatus capable of executing a function corresponding to an operation key displayed in an operation screen by the operation key being operated, comprising:
an input unit that inputs comment information for an operation key in the operation screen; and
a display control unit that displays the comment information input by the input unit in the operation screen,
wherein the display control unit displays an icon that gives notification that comment information has been input in the operation screen when the input unit has input comment information for the operation key.

2. The image forming apparatus according to claim 1, further comprising an authentication unit that performs user authentication,
wherein the display control unit is made capable of changing a color of the icon to be displayed in the operation screen for each user authenticated by the authentication unit.

3. The image forming apparatus according to claim 1, further comprising an authentication unit that performs user authentication,
wherein the display control unit is made capable of changing a shape of the icon to be displayed in the operation screen for each user authenticated by the authentication unit.

4. The image forming apparatus according to claim 1, further comprising an authentication unit that performs user authentication,
wherein the display control unit is made capable of changing a color and a shape of the icon to be displayed in the operation screen for each user authenticated by the authentication unit.

5. An image forming apparatus capable of executing a function corresponding to an operation key displayed in an operation screen by the operation key being operated, comprising:
an input unit that inputs comment information for an operation key in the operation screen; and
a display control unit that displays the comment information input by the input unit in the operation screen,
wherein when the input unit has input comment information for the operation key, the display control unit makes a display state of the operation key different from a display state in which comment information is not input for the operation key.

6. The image forming apparatus according to claim 5, further comprising an authentication unit that performs user authentication,
wherein the display control unit is made capable of changing a color of the operation key to be displayed in the operation screen for each user authenticated by the authentication unit when the input unit has input comment information for the operation key.

7. The image forming apparatus according to claim 5, further comprising an authentication unit that performs user authentication,
wherein the display control unit is made capable of changing a shape of the operation key to be displayed in the operation screen for each user authenticated by the authentication unit when the input unit has input comment information for the operation key.

8. The image forming apparatus according to claim 5, further comprising an authentication unit that performs user authentication,
wherein the display control unit is made capable of changing a color and a shape of the operation key to be displayed in the operation screen for each user authenticated by the authentication unit when the input unit has input comment information for the operation key.

9. The image forming apparatus according to claim 1,
wherein the display control unit displays content of the comment information in the operation screen using a pop-up screen when a comment display operation for displaying content of the comment information in the operation screen is detected to have been performed.

10. The image forming apparatus according to claim 9,
wherein the display control unit simultaneously displays an -instruction key used to give instructions to start an operation to process a corresponding function when displaying the pop-up screen.

11. The image forming apparatus according to claim 1, further comprising a send function for sending image data.

12. The image forming apparatus according to claim 2,
wherein the display control unit displays content of the comment information in the operation screen using a pop-up screen when a comment display operation for displaying content of the comment information in the operation screen is detected to have been performed.

13. The image forming apparatus according to claim 3,
wherein the display control unit displays content of the comment information in the operation screen using a pop-up screen when a comment display operation for displaying content of the comment information in the operation screen is detected to have been performed.

14. The image forming apparatus according to claim 4,
wherein the display control unit displays content of the comment information in the operation screen using a pop-up screen when a comment display operation for displaying content of the comment information in the operation screen is detected to have been performed.

15. The image forming apparatus according to claim 5,
wherein the display control unit displays content of the comment information in the operation screen using a pop-up screen when a comment display operation for displaying content of the comment information in the operation screen is detected to have been performed.

16. The image forming apparatus according to claim 6,
wherein the display control unit displays content of the comment information in the operation screen using a pop-up screen when a comment display operation for displaying content of the comment information in the operation screen is detected to have been performed.

17. The image forming apparatus according to claim 7,
wherein the display control unit displays content of the comment information in the operation screen using a pop-up screen when a comment display operation for displaying content of the comment information in the operation screen is detected to have been performed.

18. The image forming apparatus according to claim 8,
wherein the display control unit displays content of the comment information in the operation screen using a pop-up screen when a comment display operation for displaying content of the comment information in the operation screen is detected to have been performed.

19. The image forming apparatus according to claim 2, further comprising a send function for sending image data.

20. The image forming apparatus according to claim 3, further comprising a send function for sending image data.

21. The image forming apparatus according to claim 4, further comprising a send function for sending image data.

22. The image forming apparatus according to claim 5, further comprising a send function for sending image data.

23. The image forming apparatus according to claim 6, further comprising a send function for sending image data.

24. The image forming apparatus according to claim 7, further comprising a send function for sending image data.

25. The image forming apparatus according to claim 8, further comprising a send function for sending image data.
